(19) United States
(12) Patent Application Publication
(10) Pub. No.: US 2025/0203602 A1
(43) Pub. Date: Jun. 19, 2025

(54) UPLINK PARAMETERS PREDICTION AND INDICATION IN WIRELESS COMMUNICATION

(71) Applicant: QUALCOMM Incorporated, San Diego, CA (US)

(72) Inventors: Qiaoyu LI, Beijing (CN); Kiran VENUGOPAL, Green Brook, NJ (US); Mahmoud TAHERZADEH BOROUJENI, San Diego, CA (US); Wooseok NAM, San Diego, CA (US); Tao LUO, San Diego, CA (US)

(21) Appl. No.: 18/840,395

(22) PCT Filed: Apr. 29, 2022
(86) PCT No.: PCT/CN2022/090385

§ 371 Date: Aug. 21, 2024

(51) Int. Cl. H04W 72/1263; H04B 7/0456; H04L 5/00; H04W 24/02

(52) U.S. Cl. CPC H04W 72/1263; H04B 7/0456; H04L 5/0078; H04W 24/02

(57) ABSTRACT

Techniques used for uplink precoding scheme prediction and indication in wireless communication are disclosed. A user equipment (UE) can dynamically identify a predicted uplink precoding scheme for a future uplink transmission, for example, based on at least in part downlink control information received from a network entity and downlink measurements before the future uplink transmission. A UE can transmit a first uplink (UL) transmission scheduled by the first DCI. The UE can further transmit a second UL transmission after the first UL transmission, a precoding scheme of the second UL transmission being determined based on at least in part the first DCI.

### TECHNICAL FIELD

The technology discussed below relates generally to wireless communication systems, and more particularly, to uplink parameters prediction and indication in wireless communication.

### INTRODUCTION

Wireless communication systems are widely deployed to provide various telecommunication services such as telephony, video, data, messaging, and broadcasts. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. In a 5G network, a user equipment can transmit a sounding reference signal (SRS) using beam sweeping (SRS beam sweeping). A network entity can determine the channel quality based on the SRS beam sweeping and indicate to a user equipment an uplink precoding scheme for a future UL transmission. An exemplary precoding scheme can include one or more of an SRS resource indicator (SRI), a transmit precoder matrix indicator (TPMI), a transmit rank indicator (TRI), and a modulation and coding scheme (MCS).

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Aspects of this disclosure provide various techniques used for uplink precoding scheme prediction and indication in wireless communication. In some aspects, a user equipment can dynamically identify a predicted uplink precoding scheme for a future uplink transmission, for example, based on at least in part downlink control information received from a network entity and downlink measurements before the future uplink transmission.

One aspect of the disclosure provides a method of wireless communication at a user equipment (UE). The method includes receiving, from a network entity, a first downlink control information (DCI). The method further includes transmitting a first uplink (UL) transmission scheduled by the first DCI. The method further includes transmitting a second UL transmission after the first UL transmission, a precoding scheme of the second UL transmission being determined based on at least in part the first DCI.

Another aspect of the disclosure provides a user equipment (UE) for wireless communication. The UE includes a transceiver for wireless communication, a memory, and a processor coupled to the transceiver and the memory. The processor and the memory are configured to receive, via the transceiver, a first downlink control information (DCI). The processor and the memory are further configured to transmit, via the transceiver, a first uplink (UL) transmission scheduled by the first DCI. The processor and the memory are further configured to transmit, via the transceiver, a second UL transmission after the first UL transmission, a precoding scheme of the second UL transmission being determined based on at least in part the first DCI.

Another aspect of the disclosure provides a method of wireless communication at a network entity. The method includes transmitting a first downlink control information (DCI). The method further includes receiving a first uplink (UL) transmission scheduled by the first DCI. The method further includes receiving a second UL transmission after the first UL transmission, a precoding scheme of the second UL transmission being determined at a user equipment (UE) based on at least in part the first DCI and downlink measurements prior to the second UL transmission.

Another aspect of the disclosure provides a network entity for a communication network. The network entity includes a memory and a processor coupled to the memory. The processor and the memory are configured to transmit a first downlink control information (DCI). The processor and the memory are further configured to receive a first uplink (UL) transmission scheduled by the first DCI. The processor and the memory are configured to receive a second UL transmission after the first UL transmission, a precoding scheme of the second UL transmission being determined at a user equipment (UE) based on at least in part the first DCI and downlink measurements prior to the second UL transmission.

These and other aspects of the invention will become more fully understood upon a review of the detailed description, which follows. Other aspects, features, and implementations will become apparent to those of ordinary skill in the art, upon reviewing the following description of specific, exemplary implementations in conjunction with the accompanying figures. While features may be discussed relative to certain examples and figures below, all implementations can include one or more of the advantageous features discussed herein. In other words, while one or more implementations may be discussed as having certain advantageous features, one or more of such features may also be used in accordance with the various examples discussed herein. In a similar fashion, while examples may be discussed below as device, system, or method implementations, it should be understood that such examples can be implemented in various devices, systems, and methods.

### BRIEF DESCRIPTION OF THE DRAWINGS

FIG. 1 is a schematic illustration of a wireless communication system according to some aspects.

FIG. 2 is an illustration of an example of a radio access network (RAN) according to some aspects.

FIG. 3 is a diagram illustrating an example of a RAN including distributed entities according to some aspects.

FIG. 4 is a schematic illustration of an organization of wireless resources in an air interface utilizing orthogonal frequency divisional multiplexing (OFDM) according to some aspects.

FIG. 5 is a block diagram illustrating a wireless communication system supporting multiple-input multiple-output (MIMO) communication.

FIG. 6 is a diagram illustrating communication between a network entity and a user equipment (UE) using beamformed signals according to some aspects.

FIG. 7 is a signaling diagram illustrating exemplary signaling between a network entity and a UE to provide channel state information feedback within a wireless network.

FIG. 8 is a schematic drawing illustrating a process for predicting uplink (UL) parameters according to some aspects.

FIG. 9 is a flow chart illustrating a process for determining UE-predicted UL parameters according to some aspects.

FIG. 10 is a diagram conceptually illustrating exemplary uplink grant downlink control information according to some aspects.

FIG. 11 is a diagram illustrating exemplary UL transmissions using predicted UL parameters according to some aspects.

FIG. 12 is a diagram illustrating a process for predicting UL parameters using a machine learning model according to some aspects.

FIG. 13 is a diagram illustrating a process for predicting UL parameters using analytical techniques according to some aspects.

FIG. 14 is a flow chart illustrating a process for scheduling an UL transmission using downlink control information without including associated UL parameters according to some aspects.

FIG. 15 is a diagram illustrating an exemplary timeline of UL parameters prediction according to some aspects.

FIG. 16 is a block diagram illustrating an example of a hardware implementation for a network entity according to some aspects.

FIG. 17 is a flow chart illustrating an exemplary process for UL precoding scheme prediction at a network entity according to some aspects.

FIG. 18 is a block diagram illustrating an example of a hardware implementation for a UE according to some aspects.

FIG. 19 is a flow chart illustrating an exemplary process for UL precoding scheme prediction at a UE according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chips and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and UE), end-user devices, etc. of varying sizes, shapes and constitution.

Aspects of this disclosure provide various techniques used for uplink precoding scheme prediction and indication in wireless communication. In some aspects, a user equipment can dynamically identify a predicted uplink precoding scheme for a future uplink transmission, for example, based on at least in part downlink control information received from a network entity and downlink measurements before the future uplink transmission.

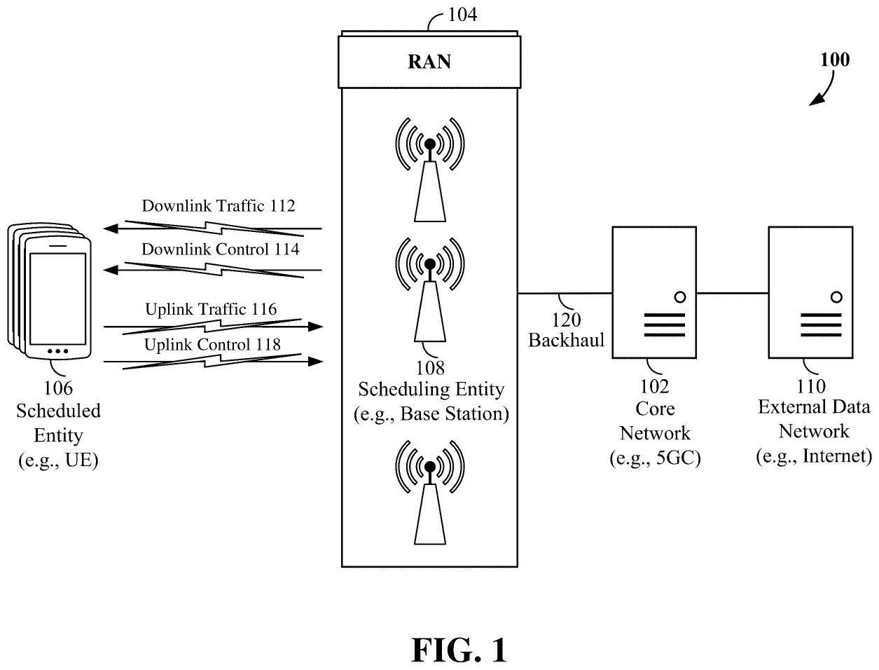

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, radio frequency (RF) chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a network entity (e.g., base station 108) to one or more UEs (e.g., UE 106) may be referred to as downlink (DL) transmission. In accordance with certain aspects of the present disclosure, the term downlink may refer to a point-to-multipoint transmission originating at a network entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a network entity (e.g., a base station 108) allocates resources for communication among some or all devices and equipment within its service area or cell. Within the present disclosure, as discussed further below, the network entity may be responsible for scheduling, assigning, reconfiguring, and releasing resources for one or more scheduled entities. That is, for scheduled communication, UEs 106, which may be scheduled entities, may utilize resources allocated by the network entity 108.

Base stations 108 are not the only entities that may function as scheduling entities. That is, in some examples, a UE may function as a network entity, scheduling resources for one or more scheduled entities (e.g., one or more other UEs).

As illustrated in FIG. 1, a network entity 108 (e.g., a base station) may broadcast downlink traffic 112 to one or more scheduled entities 106. Broadly, the network entity 108 is a node or device responsible for scheduling traffic in a wireless communication network, including the downlink traffic 112 and, in some examples, uplink traffic 116 from one or more scheduled entities 106 to the network entity 108. On the other hand, the scheduled entity 106 is a node or device that receives downlink control information 114, including but not limited to scheduling information (e.g., a grant), synchronization or timing information, or other control information from another entity in the wireless communication network such as the network entity 108. The scheduled entity 106 may further transmit uplink control information 118, including but not limited to a scheduling request or feedback information, or other control information to the network entity 108.

In addition, the uplink and/or downlink control information 114 and/or 118 and/or traffic information 112 and/or 116 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

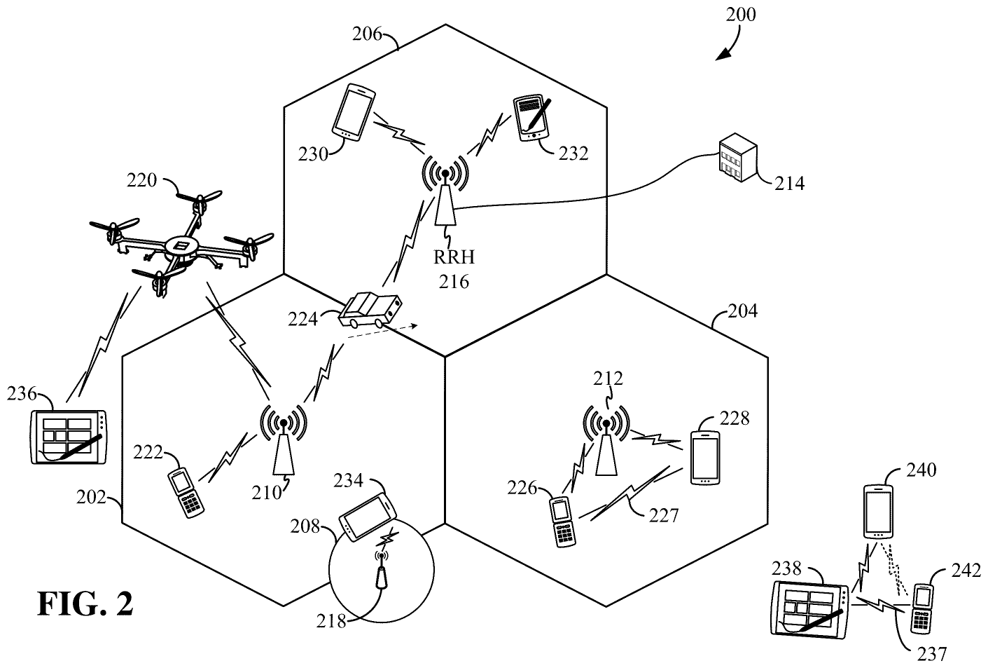

FIG. 2 is an illustration of an example of a RAN 200 according to some aspects. In some examples, the RAN 200 may be the same as the RAN 104 described above and illustrated in FIG. 1. The geographic area covered by the RAN 200 may be divided into cellular regions (cells) that can be uniquely identified by a UE based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the network entity 108 described above and illustrated in FIG. 1.

FIG. 2 further includes an unmanned aerial vehicle (UAV) 220, which may be a quadcopter or drone. The UAV 220 may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, the UAV 220 (e.g., quadcopter) may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink networks. For example, two or more UEs (e.g., UEs 238, 240, and 242) may communicate with each other using sidelink signals 237 without relaying that communication through a base station. In some examples, the UEs 238, 240, and 242 may each function as a scheduling entity (e.g., network entity 108) or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In the RAN 200, the ability of a UE to communicate while moving, independent of its location, is referred to as mobility. The various physical channels between the UE and the RAN 200 are generally set up, maintained, and released under the control of an access and mobility management function (AMF, not illustrated, part of the core network 102 in FIG. 1), which may include a security context management function (SCMF) and a security anchor function (SEAF) that perform authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if the signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the RAN (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may hand over the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next-generation communication networks enables the uplink-based mobility framework and improves the efficiency of both the UE and the network, since the number of mobility messages that need to be exchanged between the UE and the network may be reduced.

The air interface in the RAN 200 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

Further, the air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

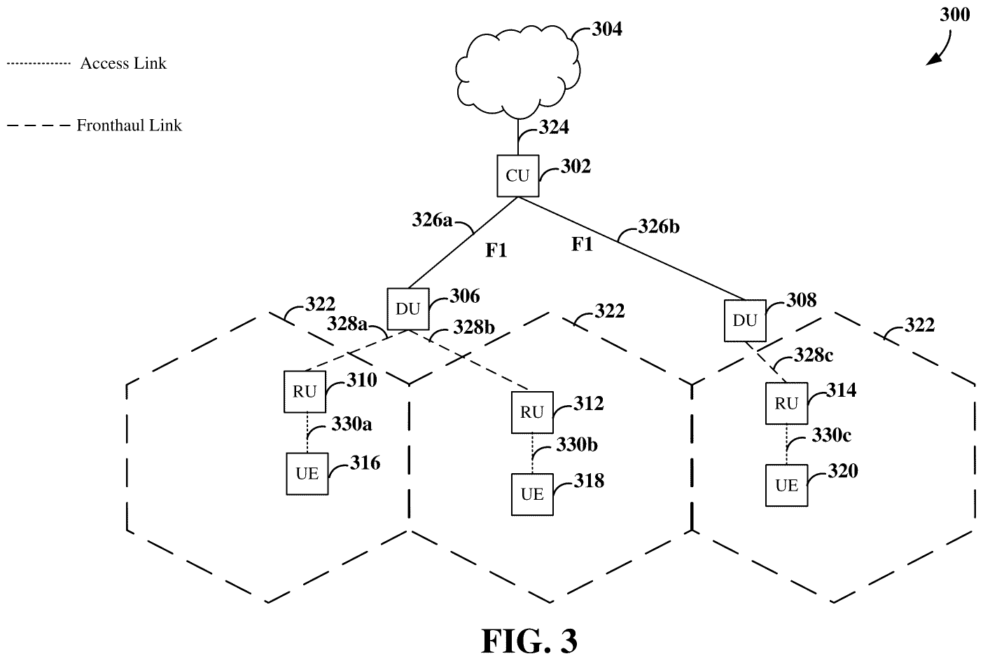

FIG. 3 is a diagram illustrating an example of a RAN 300 including distributed entities according to some aspects. The RAN 300 may be similar to the radio access network 200 shown in FIG. 2, in that the RAN 300 may be divided into a number of cells (e.g., cells 322) each of which may be served by respective network entities (e.g., control units, distributed units, and radio units). The network entities may constitute access points, TRPs, base stations (BSs), eNBs, gNBs, or other nodes that utilize wireless spectrum (e.g., the radio frequency (RF) spectrum) and/or other communication links to support access for one or more UEs located within the cells. In some examples, some or all of the network entities of FIG. 3 may be implemented within an integrated access backhaul (IAB) network. In some examples, some or all of the nodes of FIG. 3 may be implemented according to an open-radio access network (O-RAN) architecture.

In the example of FIG. 3, a control unit (CU) 302 communicates with a core network 304 via a backhaul link 324, and communicates with a first distributed unit (DU) 306 and a second distributed unit 308 via respective midhaul links 326a and 326b. The first distributed unit 306 communicates with a first radio unit (RU) 310 and a second radio unit 312 via respective fronthaul links 328a and 328b. The second distributed unit 308 communicates with a third radio unit 314 via a fronthaul link 328c. The first radio unit 310 communicates with at least one UE 316 via at least one RF access link 330a. The second radio unit 312 communicates with at least one UE 318 via at least one RF access link 330b. The third radio unit 314 communicates with at least one UE 320 via at least one RF access link 330c.

In some examples, a control unit (e.g., the CU 302) is a logical node that hosts a packet data convergence protocol (PDCP) layer, a radio resource control (RRC) layer, a service data adaptation protocol (SDAP) layer and other control functions. A control unit may also terminate interfaces (e.g., an E1 interface, an E2 interface, etc., not shown in FIG. 3) to core network nodes (e.g., nodes of a core network). In addition, an F1 interface (not shown in FIG. 3) may provide a mechanism to interconnect a CU 302 (e.g., the PDCP layer and higher layers) and a DU (e.g., the radio link control (RLC) layer and lower layers). In some aspects, an F1 interface may provide control plane and user plane functions (e.g., interface management, system information management, UE context management, RRC message transfer, etc.). For example, the F1 interface may support F1-C on the control plane and F1-U on the user plane. F1AP is an application protocol for F1 that defines signaling procedures for F1 in some examples.

In some examples, a DU (e.g., the DU 306 or the DU 308) is a logical node that hosts an RLC layer, a medium access control (MAC) layer, and a high physical (PHY) layer based on a lower layer functional split (LLS). In some aspects, a DU may control the operation of at least one RU. A DU may also terminate interfaces (e.g., F1, E2, etc.) to the CU and/or other network nodes. In some examples, a high PHY layer includes portions of the PHY processing such as forward error correction 1 (FEC 1) encoding and decoding, scrambling, modulation, and demodulation.

In some examples, an RU (e.g., the RU 310, the RU 312, or the RU 314) is a logical node that hosts low PHY layer and radio frequency (RF) processing based on a lower layer functional split. In some examples, a RU may be similar to a 3GPP transmit receive point (TRP) or remote radio head (RRH), while also including the low PHY layer. In some examples, a low PHY layer includes portions of the PHY processing such as fast Fourier transform (FFT), inverse FFT (iFFT), digital beamforming, and physical random access channel (PRACH) extraction and filtering. The RU may also include a radio (e.g., radio frequency (RF)) chain for communicating with one or more UEs.

The functionality splits between the entities of the RAN 300 may be different in different examples. In some examples, Layer 1 functions, Layer 2 functions, and Layer 3 functions may be allocated among the RU, DU, and CU entities. Examples of Layer 1 functions include RF functions and low PHY layer functions. Examples of Layer 2 functions include high PHY layer functions, low MAC layer functions, high MAC layer functions, low RLC layer functions, and high RLC layer functions. Examples of Layer 3 functions include PDCP layer functions and RRC layer functions. Other functionality splits may be used in other examples.

As discussed above, the two Layer 3 functions may be implemented in a CU. The other Layer 1 and Layer 2 functions may thus be split between the RU and the DU in this case. In some examples, the Layer 1 functions are implemented in the RU and the Layer 3 functions are implemented in the DU. In some examples, all PHY functionality is implemented in the RU (i.e., the high PHY layer functions are implemented in the RU and not the DU). Other functionality splits may be used in other examples.

Different splits may be used between low layer functionality and high layer functionality in different examples. For example, the split between the low PHY layer functionality and the high PHY layer functionality may be defined between RE mapping and precoding in some cases. Thus, the RE mapping may be designated as a low PHY layer function performed by an RU and the precoding may be designated as a high PHY layer function performed by a DU in such a case. Other functionality splits may be used in other examples.

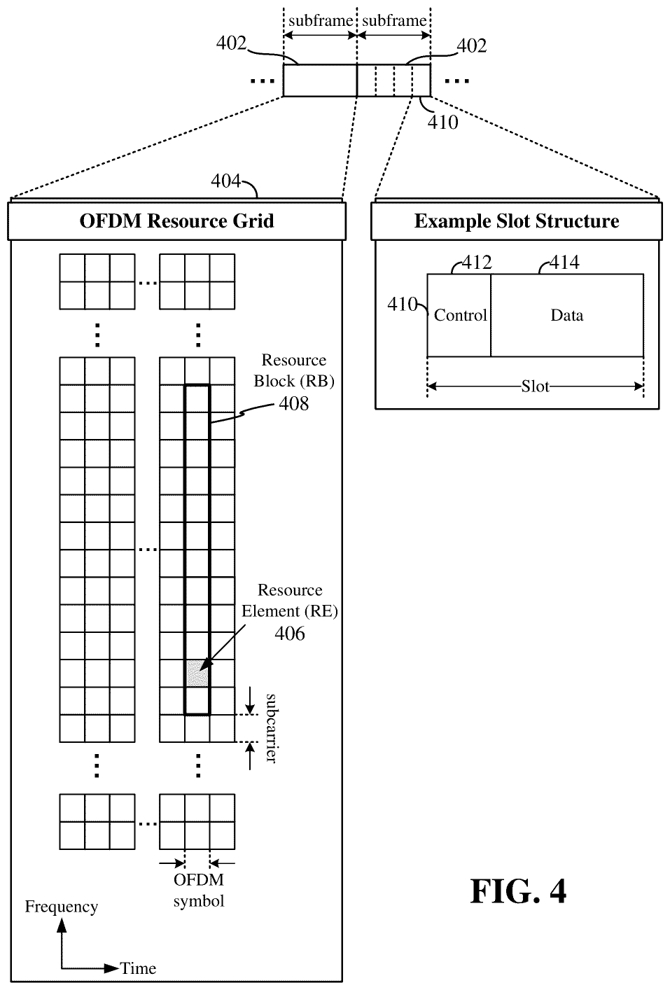

FIG. 4 is a schematic illustration of an organization of wireless resources in an air interface utilizing orthogonal frequency divisional multiplexing (OFDM) according to some aspects. Various aspects of the present disclosure will be described with reference to an OFDM waveform, schematically illustrated in FIG. 4. It should be understood by those of ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 4, an expanded view of an exemplary subframe 402 is illustrated, showing an OFDM resource grid. However, as those skilled in the art will readily appreciate, the physical layer (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a network entity, such as a base station, gNB, eNB, etc., or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the network entity (e.g., a base station or a scheduling entity) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity (e.g., base station) may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 406 to carry UL control information (UCI) including one or more UL control channels, such as a physical uplink control channel (PUCCH), to the network entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., a request for the network entity to schedule uplink transmissions. Here, in response to the SR transmitted on the UCI, the network entity may transmit a DCI that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 4 are not necessarily all of the channels or carriers that may be utilized between devices, and those of ordinary skill in the art will recognize that other channels or carriers may be utilized in addition to those illustrated, such as other traffic, control, and feedback channels.

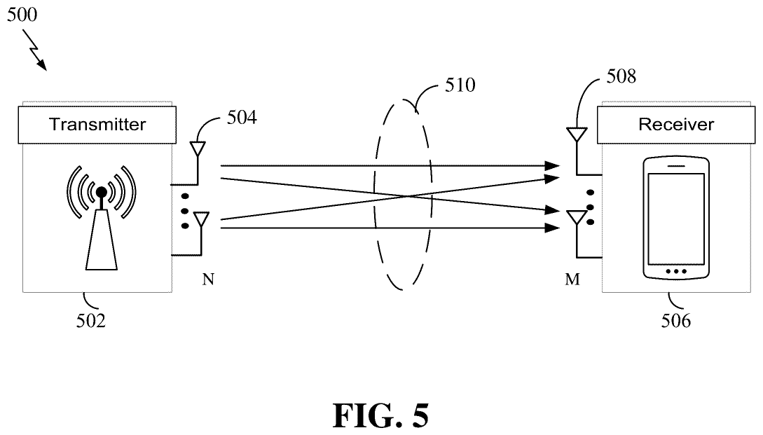

In some aspects of the disclosure, the network entity (e.g., base station) and/or scheduled entity (e.g., UE) may be configured for beamforming and/or multiple-input multiple-output (MIMO) technology. FIG. 5 illustrates an example of a wireless communication system 500 supporting MIMO and beamforming. In a MIMO system, a transmitter 502 includes multiple transmit antennas 504 (e.g., N transmit antennas) and a receiver 506 includes multiple receive antennas 508 (e.g., M receive antennas). Thus, there are N×M signal paths 510 from the transmit antennas 504 to the receive antennas 508. Each of the transmitter 502 and the receiver 506 may be implemented, for example, within a network entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 500 is limited by the number of transmit or receive antennas 504 or 508, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on an SRS transmitted from the UE or other pilot signal). Based on the assigned rank, the base station may then transmit CSI-RSs with separate C-RS sequences for each layer to provide for multi-layer channel estimation. From the CSI-RS, the UE may measure the channel quality across layers and resource blocks and feed back the RI and a channel quality indicator (CQI) that indicates to the base station a modulation and coding scheme (MCS) to use for transmissions to the UE for use in updating the rank and assigning REs for future downlink transmissions.

In the simplest case, as shown in FIG. 5, a rank-2 spatial multiplexing transmission on a 2×2 MIMO antenna configuration will transmit one data stream from each transmit antenna 504. Each data stream reaches each receive antenna 508 along a different signal path 510. The receiver 506 may then reconstruct the data streams using the received signals from each receive antenna 508.

Beamforming is a signal processing technique that may be used at the transmitter 502 or receiver 506 to shape or steer an antenna beam (e.g., a transmit beam or receive beam) along a spatial path between the transmitter 502 and the receiver 506. Beamforming may be achieved by combining the signals communicated via antennas 504 or 508 (e.g., antenna elements of an antenna array module) such that some of the signals experience constructive interference while others experience destructive interference. To create the desired constructive/destructive interference, the transmitter 502 or receiver 506 may apply amplitude and/or phase offsets to signals transmitted or received from each of the antennas 504 or 508 associated with the transmitter 502 or receiver 506.

The electromagnetic spectrum is often subdivided, based on frequency/wavelength, into various classes, bands, channels, etc. In 5G NR two initial operating bands have been identified as frequency range designations FR1 (410 MHZ-7.125 GHz) and FR2 (24.25 GHz-52.6 GHz). It should be understood that although a portion of FR 1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHZ-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In 5G NR systems, particularly for FR2 (e.g., millimeter wave) systems, beamformed signals may be utilized for most downlink channels, including the PDCCH and PDSCH. In addition, broadcast control information, such as the SSB, slot format indicator (SFI), and paging information, may be transmitted in a beam-sweeping manner to enable all scheduled entities (e.g., UEs) in the coverage area of a network entity (e.g., base station, gNB, TRP) to receive the broadcast control information. In addition, for UEs configured with beamforming antenna arrays, beamformed signals may also be utilized for uplink channels, including the PUCCH and PUSCH.

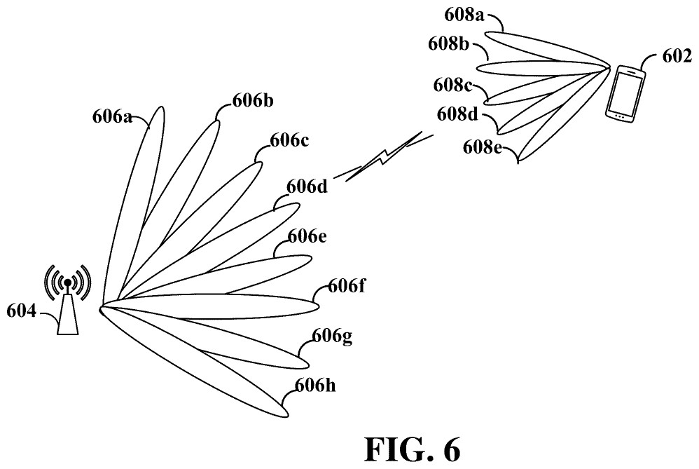

FIG. 6 is a diagram illustrating communication between a network entity 604 and a UE 602 using beamformed signals according to some aspects. The network entity 604 may be any of the base stations (e.g., gNB, CU, DU) or scheduling entities illustrated in FIGS. 1 and/or 2, and the UE 602 may be any of the UEs or scheduled entities illustrated in FIGS. 1 and/or 2.

The network entity 604 may generally be capable of communicating with the UE 602 using one or more transmit beams, and the UE 602 may further be capable of communicating with the network entity 604 using one or more receive beams. As used herein, the term transmit beam refers to a beam on the network entity 604 that may be utilized for downlink or uplink communication with the UE 602. In addition, the term receive beam refers to a beam on the UE 602 that may be utilized for downlink or uplink communication with the network entity 604.

In the example shown in FIG. 6, the network entity 604 is configured to generate a plurality of transmit beams 606a-606h, each associated with a different spatial direction. In addition, the UE 602 is configured to generate a plurality of receive beams 608a-608e, each associated with a different spatial direction. It should be noted that while some beams are illustrated as adjacent to one another, such an arrangement may be different in different aspects. For example, transmit beams 606a-606h transmitted during a same symbol may not be adjacent to one another. In some examples, the network entity 604 and UE 602 may each transmit more or less beams distributed in all directions (e.g., 360 degrees) and in three-dimensions. In addition, the transmit beams 606a-606h may include beams of varying beam width. For example, the network entity 604 may transmit certain signals (e.g., SSBs) on wider beams and other signals (e.g., CSI-RSs) on narrower beams.

The network entity 604 and UE 602 may select one or more transmit beams 606a-606h on the network entity 604 and one or more receive beams 608a-608e on the UE 602 for communication of uplink and downlink signals therebetween using a beam management procedure. In one example, during initial cell acquisition, the UE 602 may perform a P1 beam management procedure to scan the plurality of transmit beams 606a-606h on the plurality of receive beams 608a-608e to select a beam pair link (e.g., one of the transmit beams 606a-606h and one of the receive beams 608a-608e) for a physical random access channel (PRACH) procedure for initial access to the cell. For example, periodic SSB beam sweeping may be implemented on the network entity 604 at certain intervals (e.g., based on the SSB periodicity). Thus, the network entity 604 may be configured to sweep or transmit an SSB on each of a plurality of wider transmit beams 606a-606h during the beam sweeping interval. The UE may measure the reference signal received power (RSRP) of each of the SSB transmit beams on each of the receive beams of the UE and select the transmit and receive beams based on the measured RSRP. In an example, the selected receive beam may be the receive beam on which the highest RSRP is measured and the selected transmit beam may have the highest RSRP as measured on the selected receive beam.

After completing the PRACH procedure, the network entity 604 and UE 602 may perform a P2 beam management procedure for beam refinement at the network entity 604. For example, the network entity 604 may be configured to sweep or transmit a DL reference signal (e.g., CSI-RS) on each of a plurality of narrower transmit beams (e.g., beams 606a-606h). Each of the narrower CSI-RS beams may be a sub-beam of the selected SSB transmit beam (e.g., within the spatial direction of the SSB transmit beam). Transmission of the CSI-RS transmit beams may occur periodically (e.g., as configured via radio resource control (RRC) signaling by the network entity), semi-persistently (e.g., as configured via RRC signaling and activated/deactivated via MAC-CE signaling by the network entity), or aperiodically (e.g., as triggered by the network entity via DCI). The UE 602 is configured to scan the plurality of CSI-RS transmit beams 606a-606h on the plurality of receive beams 608a-608e. The UE 602 then performs beam measurements (e.g., RSRP, SINR, etc.) of the received CSI-RSs on each of the receive beams 608a-608e to determine the respective beam quality of each of the CSI-RS transmit beams 606a-606h as measured on each of the receive beams 608a-608e.

The UE 602 can then generate and transmit a Layer 1 (L1) measurement report, including the respective beam index (e.g., CSI-RS resource indicator (CRI)) and beam measurement (e.g., RSRP or SINR) of one or more of the CSI-RS transmit beams 606a-606h on one or more of the receive beams 608a-608e to the network entity 604. The network entity 604 may then select one or more CSI-RS transmit beams on which to communicate downlink and/or uplink control and/or data with the UE 602. In some examples, the selected CSI-RS transmit beam(s) have the highest RSRP from the L1 measurement report. Transmission of the L1 measurement report may occur periodically (e.g., as configured via RRC signaling by the network entity), semi-persistently (e.g., as configured via RRC signaling and activated/deactivated via MAC-CE signaling by the network entity), or aperiodically (e.g., as triggered by the network entity via DCI).

The UE 602 may further select a corresponding receive beam on the UE 602 for each selected serving CSI-RS transmit beam to form a respective beam pair link (BPL) for each selected serving CSI-RS transmit beam. For example, the UE 602 can utilize the beam measurements obtained during the P2 procedure or perform a P3 beam management procedure to obtain new beam measurements for the selected CSI-RS transmit beams to select the corresponding receive beam for each selected transmit beam. In some examples, the selected receive beam to pair with a particular CSI-RS transmit beam may be the receive beam on which the highest RSRP for the particular CSI-RS transmit beam is measured.

In some examples, in addition to performing CSI-RS beam measurements, the network entity 604 may configure the UE 602 to perform SSB beam measurements and provide an L1 measurement report containing beam measurements of SSB transmit beams 606a-606h. For example, the network entity 604 may configure the UE 602 to perform SSB beam measurements and/or CSI-RS beam measurements for beam failure detection (BFD), beam failure recovery (BFR), cell reselection, beam tracking (e.g., for a mobile UE 602 and/or network entity 604), or other beam optimization purpose.

In addition, when the channel is reciprocal, the transmit and receive beams may be selected using an uplink beam management scheme. In one example, the UE 602 may be configured to sweep or transmit on each of a plurality of receive beams 608a-608e. For example, the UE 602 may transmit an SRS on each beam in different beam directions (i.e., SRS beam sweeping). In addition, the network entity 604 may be configured to receive the uplink beam reference signals (e.g., SRS) on a plurality of transmit beams 606a-606h. The network entity 604 then performs beam measurements (e.g., RSRP, SINR, etc.) of the beam reference signals on each of the transmit beams 606a-606h to determine the respective beam quality of each of the receive beams 608a-608e as measured on each of the transmit beams 606a-606h.

The network entity 604 may then select one or more transmit beams on which to communicate downlink and/or uplink control and/or data with the UE 602. In some examples, the selected transmit beam(s) have the highest RSRP. The UE 602 may then select a corresponding receive beam for each selected serving transmit beam to form a respective beam pair link (BPL) for each selected serving transmit beam, using, for example, a P3 beam management procedure, as described above.

In one example, a single CSI-RS transmit beam (e.g., beam 606d) on the network entity 604 and a single receive beam (e.g., beam 608c) on the UE may form a single BPL used for communication between the network entity 604 and the UE 602. In another example, multiple CSI-RS transmit beams (e.g., beams 606c, 606d, and 606e) on the network entity 604 and a single receive beam (e.g., beam 608c) on the UE 602 may form respective BPLs used for communication between the network entity 604 and the UE 602. In another example, multiple CSI-RS transmit beams (e.g., beams 606c, 606d, and 606e) on the network entity 604 and multiple receive beams (e.g., beams 608c and 608d) on the UE 602 may form multiple BPLs used for communication between the network entity 604 and the UE 602. In this example, a first BPL may include transmit beam 606c and receive beam 608c, a second BPL may include transmit beam 608d and receive beam 608c, and a third BPL may include transmit beam 608e and receive beam 608d.

In addition to L1 measurement reports, the UE 602 can further utilize the beam reference signals to estimate the channel quality of the channel between the network entity 604 and the UE 602. For example, the UE 602 may measure the SINR of each received CSI-RS and generate a CSI report based on the measured SINR. The CSI report may include, for example, a channel quality indicator (CQI), rank indicator (RI), precoding matrix indicator (PMI), and/or layer indicator (LI). The network entity (e.g., gNB) may use the CSI report to select a rank for the UE, along with a precoding matrix and a MCS to use for future downlink transmissions to the UE. The MCS may be selected from one or more MCS tables, each associated with a particular type of coding (e.g., polar coding, LDPC, etc.) or modulation (e.g., binary phase shift keying (BPSK), quadrature phase shift keying (QPSK), 16 quadrature amplitude modulation (QAM), 64 QAM, 256 QAM, etc.). The LI may be utilized to indicate which column of the precoding matrix of the reported PMI corresponds to the strongest layer codeword corresponding to the largest reported wideband CQI.

### Uplink Parameters

In a wireless network (e.g., 5G NR), precoding can be used for UL communication (e.g., SRS and PUSCH transmissions). Precoding assumes that channel state information is known at the transmitter (e.g., UE for UL transmissions). Precoding can start with channel sounding that involves sending a coded message (e.g., SRS) to a network entity (e.g., a gNB), then the network entity can determine channel state information based on the sounding message and provides uplink precoding information for subsequent UL transmission (e.g., PUSCH). For the sounding message, the UE can sweep the UL beam across multiple SRS resources. Depending on the configurations (e.g., antenna panels, number of beams, polarizations) of the network entity and the UE, the UE may perform beam-sweeping across a large number of beam pairs. However, beam-sweeping across a large number of beams or SRS resources can consume a significant amount of power and increase the processing overhead at the UE.

In some aspects, a UE can transmit SRS using one or more SRS resources, and an SRS resource can have up to four ports. Each SRS resource can include a set of SRS resource parameters configuring the SRS resource. For example, the SRS resource parameters may include a set of port(s), a number of consecutive symbols (Nsymb), time domain allocation (Ioffset), repetition, transmission comb structure (kTC), bandwidth (mSRS), and other suitable parameters. An SRS resource set may include one or more SRS resources, and multiple SRS resource sets may be configured for a UE. In addition, each SRS resource set may be configured to be periodic, aperiodic, or semi-persistent, such that each of the SRS resources within the corresponding SRS resource set are periodic, aperiodic, or semi-persistent, respectively.

The network entity (e.g., a base station) can determine UL parameters based on the received SRS sweep and indicate to the UE certain UL parameters for an uplink transmission (e.g., SRS, PUSCH). For example, the UL parameters can include an SRS resource indicator (SRI), a transmit precoder matrix indicator (TPMI), and a transmit rank indicator (TRI). The SRI indicates the selected SRS resource. The TRI indicates the preferred transmission rank. The TPMI indicates the preferred precoder over the ports in the selected SRS resource, and the precoder can be selected from the uplink codebook. Then, the UE can perform the uplink transmission based on the SRI, TRI, and TPMI. In some aspects, the UL parameters can further include the MCS and the uplink resources where the PUSCH is to be transmitted. In this disclosure, UL parameters can include one or more of: SRI, TPMI, TRI, MCS, and PUSCH resources.

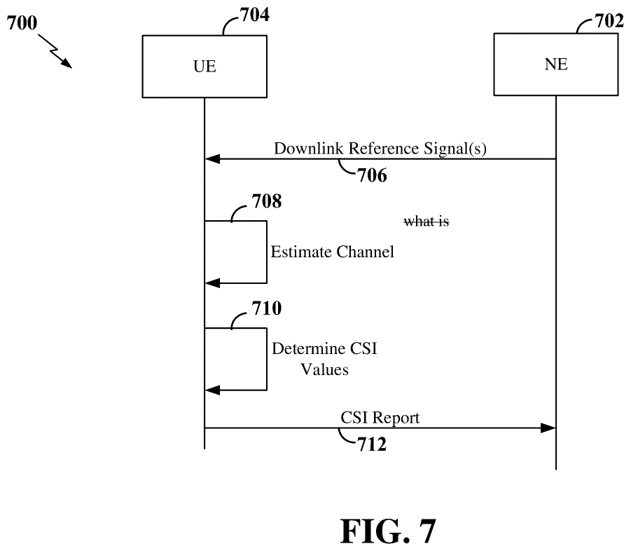

FIG. 7 is a signaling diagram illustrating exemplary signaling 700 between a network entity (NE) 702 and a UE 704 to provide channel state information feedback (CSF) within a wireless network. In the illustrated scenario, the UE 704 can provide a CSI report to the network entity 702. The network entity 702 may correspond, for example, to a base station (e.g., gNB or eNB) or other network entity or nodes as shown in FIGS. 1, 2, and/or 3. The network entity 702 may be implemented as an aggregated base station or a disaggregated base station. In a disaggregated base station architecture, the network entity 702 may include one or more of a central unit (CU), a distributed unit (DU), or a radio unit (RU). The UE 704 may correspond, for example, to a UE or other scheduled node as shown in FIGS. 1, 2, and/or 3.

At 706, the network entity 702 may transmit a reference signal, such as a CSI-RS or SSB, to the UE 704. In some examples, the reference signal may include a plurality of reference signals. Reference signals may be transmitted via a respective channel measurement resource. Channel measurement resources may include time-frequency resources, along with a beam direction, within which a particular reference signal can be transmitted. For example, channel measurement resources may include a non-zero-power (NZP) CSI-RS resource. NZP resources can be utilized for channel measurement, along with one or more interference measurement resources that may be utilized for interference measurements. Interference measurement resources may include a zero-power (ZP) CSI-RS resource and an NZP CSI-RS resource with similar properties as the NZP CSI-RS resource utilized for channel measurement. In addition, each reference signal may include a number of pilots allocated within the respective channel measurement resource.

At 708, the UE 704 can estimate the wireless channel based on the reference signal(s). For example, the UE 704 may measure the SINR of one or more of the reference signals to obtain a channel estimate of the wireless channel.

At 710, the UE 704 may determine various CSI values from the channel estimate. For example, the UE 704 may determine a RI, PMI, and CQI from the channel estimate. The CQI may include an index (e.g., a CQI index) ranging, for example, from 0 to 15. The CQI index may indicate, for example, the highest MCS at which the Block Error Rate (BLER) of the channel does not exceed 10%. Once determined, the CSI values can be fed back. For example, at 712, the UE 504 may transmit a CSI report, including the determined CSI values to the network entity 702.

The network entity 702 and UE 704 may each support different types of CSI reports (including L1 measurement reports) and/or different types of measurements. To distinguish between the different report/measurement types and measurement configurations, the network entity 702 may configure the UE 704 with one or more report settings. Each report setting may be associated with a resource setting indicating a configuration of one or more reference signals (e.g., CSI-RSs) for use in generating the CSI report.

In some aspects, a network entity (e.g., gNB, CU, or DU) can determine an UL beam (or beam parameters) of a UE by beam sweeping across multiple SRS resources. In one example, a network entity may use one antenna panel/array to communicate with the UE, and the antenna panel may support thirty-two transmit beams (e.g., beams 605a-606h) at two polarizations. The UE may have two antenna panels/arrays that can support four receive beams (e.g., beam 608a to 608e) per panel at two polarizations. In this case, the network entity needs to process 1024 beam pairs. In another example, the network entity can use TDMed SRS resources with respect to eight transmit beams for a certain antenna panel, and the network entity can indicate the SRS resources (e.g., SRI) to the UE when scheduling the UE's PUSCH. However, SRS-based beam sweeping is power and overhead intensive for the UE.

Aspects of the present disclosure provide techniques and apparatuses that can reduce SRS beam sweeping. In some aspects, SRS based beam sweeping related power and/or overhead can be used reduced using time domain UL parameters (e.g., SRI, TPMI, etc.) prediction. In some aspects, a UE can use machine learning (ML) model to generate UL parameters prediction can be used to realize such power/OH reduction. For example, the input of the ML model can include at least one of: historically received UL parameters; network indicated (coarse) UL parameter predictions targeting a future time instance that can guide the UE to extrapolate towards a certain direction in UL parameter prediction; and other channel characteristics based on DL-RS measurements/predictions. The output of the ML model can provide the UL parameters predictions (e.g., SRI/TPMI predicted for another future time instance).

To facilitate the above described UL parameter prediction techniques, an UL-grant DCI can signal the predicted UL parameters targeting a future time instance. In some aspects, the ML model can be defined in a communication standard (e.g., 3GPP NR standard). The definition of the ML model may include input, output, model training, modem inference, etc. Associations between DL reference signals and UL parameters prediction can be predefined.

Aspects of the disclosure provide various techniques for determining predicted UL parameters for future UL transmission so that the power consumption and overhead associated with UL transmission can be reduced at a wireless apparatus. In some aspects, a UE can use the disclosed techniques to predict UL parameters of a precoding scheme to realize power and overhead saving at the UE.

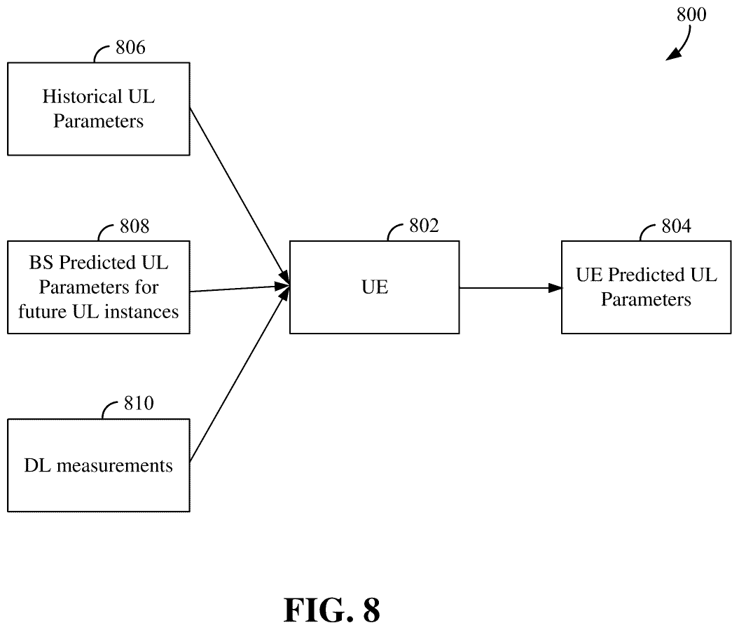

FIG. 8 is a schematic drawing illustrating a process 800 for predicting UL parameters according to some aspects. In one aspect, a UE 802 can predict UL parameters 804 for potential future instances of uplink transmissions (e.g., SRS/PUSCH) based on at least in part historical UL parameters 806 received from a network entity (e.g., a base station, gNB), base station (BS) predicted UL parameters 808 for a future instance of UL transmission, and/or DL measurements 810. Examples of DL measurements may be L1 measurements (e.g., RSRP or SINR) of a DL reference signal (e.g., SSB, CSI-RS). In one aspect, the historical UL parameters may include SRI, TPMI, and/or MCS information received by the UE for past UL transmissions. Similarly, the base station predicted UL parameters 808 and UE predicted UL parameters 804 may include SRI, TPMI, and/or MCS information for future UL transmissions (e.g., PUSCH, SRS). The base station predicted UL parameters 808 can help the UE in determining (e.g., using interpolation/extrapolation) the UE predicted UL parameters 804.

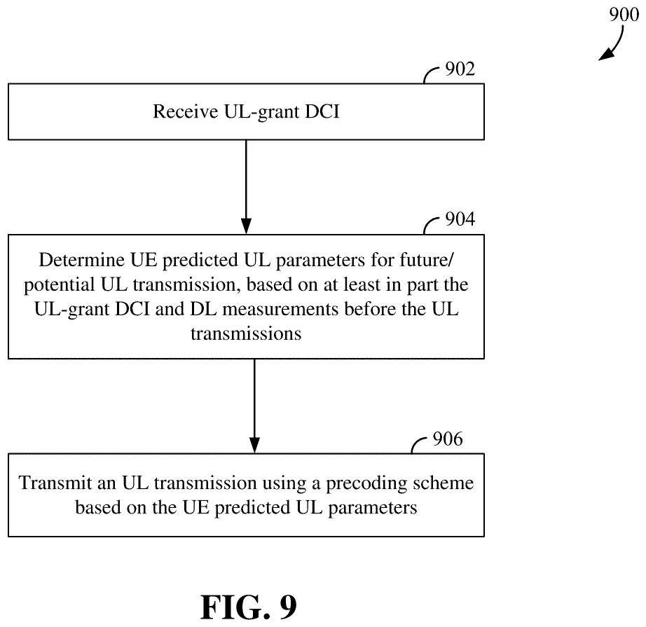

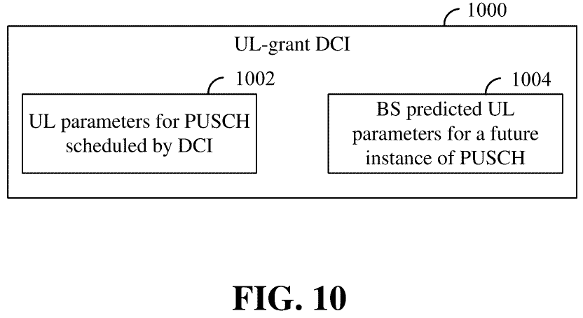

FIG. 9 is a flow chart illustrating a process 900 for determining UE-side predicted UL parameters according to some aspects. For example, the process can be performed by the UE 602, 704, or 802 described above. At block 902, a UE can receive downlink control information (e.g., an UL-grant DCI) from a network entity (e.g., network entity 604). An exemplary UL-grant DCI 1000 (see FIG. 10) can schedule or trigger a PUSCH and provide UL parameters 1002 for the PUSCH transmission. The UL-grant DCI 1000 also can provide base station predicted UL parameters 1004 for an instance of future PUSCH transmission. In one aspect, the UL-grant DCI 1000 can use a new DCI format that is different from existing DCI formats that do not provide predicted UL parameters. In one aspect, the UL-grant DCI 1000 can be scrambled with a specific Radio Network Temporary Identifier (RNTI) to indicate that the UL-grant DCI includes base station predicted UL parameters. In one aspect, the UL-grant DCI 1000 can use reserved bits in a DCI format to convey the base station predicted UL parameters (e.g., SRI, TPMI, MCS). In one aspect, the network entity can configure the UE to recognize the UL-grant DCI format, for example, using RRC configuration. In one aspect, the UL-grant DCI format can be predefined in a standard specification (e.g., 3GPP specification) governing the communication between the network entity and the UE.

At block 904, the UE can determine UE-side predicted UL parameters (e.g., UL parameters 804) for one or more future or potential UL transmissions (e.g., PUSCH transmission), based on at least in part the UL-grant DCI and DL measurements (e.g., L1 measurements of SSB and/or CSI-RS) that are obtained before the future UL transmissions. In this case, the UL-grant DCI may not directly schedule the future UL transmission. The UE predicted UL parameters can be used for future UL transmission(s) that occur before the DCI indicated future UL transmission associated with the base station predicted UL parameters included in the DCI.

At block 906, the UE can transmit an UL transmission using a precoding scheme based on the UE predicted UL parameters. In one example, the UE can select SRS resources based on the SRI indicated by the UE predicted UL parameters. In one example, the UE can select a precoder based on the TPMI indicated by the UE predicted UL parameters. In one example, the UE can select an MCS for the UL transmission based on UE predicted UL parameters.

In some aspects, the UE can predict the UL parameters for a future or potential UL transmission (e.g., PUSCH) based on more or more factors. A first factor can be base station predicted UL parameters indicated by an UL-grant DCI as described above. A second factor can be UL parameters indicated by the UL-grant DCI for a PUSCH scheduled by the same DCI. A third factor can be historical UL parameters received by the UE. In one example, the UE can consider the time instances associated with the reception of the historical UL parameters. In one example, the UE can consider the time instances associated with the reception of the historical UL parameters (e.g., SRIs and TPMIs). In one example, the UE can consider the time instances associated with the latest SRS transmission preceding the time instances of the reception of the historical UL parameters.

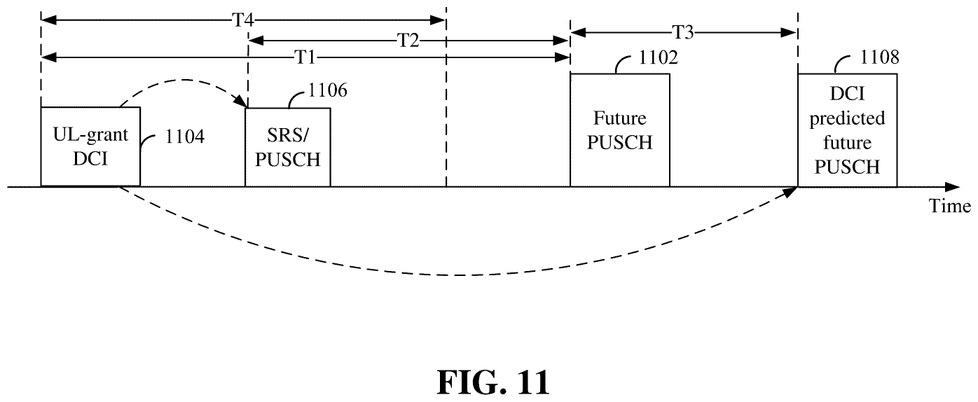

A fourth factor can be time differences associated with the UL parameter predictions and channel measurements. In one example, the UE can consider the time difference (e.g., T1 in FIG. 11) between the time (e.g., symbol/slot) of a future PUSCH 1102 and the time (e.g., symbol/slot) receiving the UL-grant DCI 1104. In one example, the UE can consider the time difference (e.g., T2 in FIG. 11) between the time of a future PUSCH 1102 and the time transmitting the SRS 1106 that is associated with the indicated UL parameters targeting a PUSCH (e.g., PUSCH 1108) scheduled by the UL-grant DCI 1104. In one example, the UE can consider the time difference (e.g., T3 in FIG. 11) between the time (e.g., symbol/slot) of the future PUSCH 1102 and the time instance of the future PUSCH 1108 targeted by the BS predicted UL parameters indicated in the UL-grant DCI 1104. In one example, the UE can consider the time difference (e.g., T4 in FIG. 11) between the time receiving the UL-grant DCI 1104 and a time instance preceding the future PUSCH 1102 but later than the time instance of receiving the UL-grant DCI 1104.

A fifth factor can be DL measurements, if applicable. For example, the UE can consider the estimated or predicted channel quality or condition based on measurements of DL reference signals (e.g., SSBs and CSI-RSs). For example, channel profiles can be estimated from CSI-RS, SSB, or DMRS, which can be used as input to the ML model for predicting UL parameters. Channel quality can affect the determination of UL parameters or precoding scheme used by the UE.

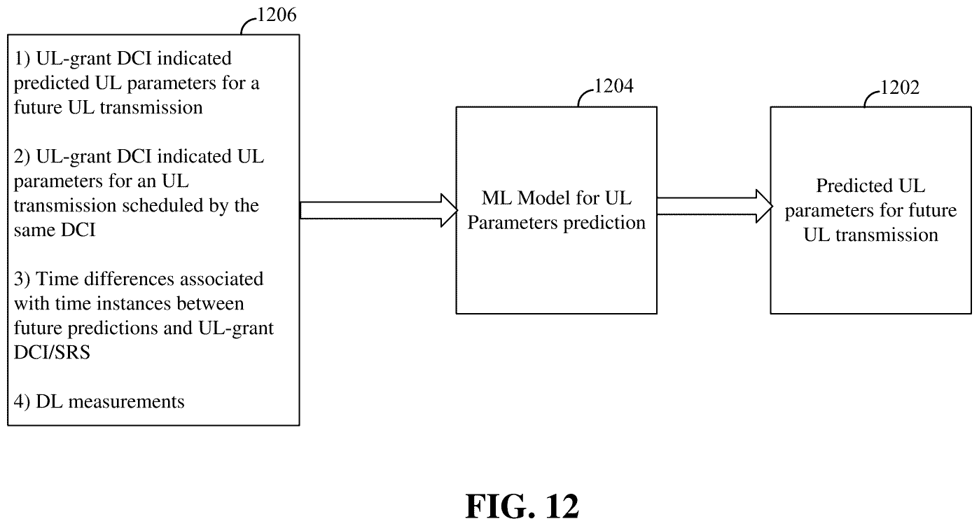

In some aspects of the disclosure, the UE can predict the UL parameters for potential or future UL transmissions (e.g., PUSCH) using machine learning (ML) techniques. FIG. 12 is a diagram illustrating a process of predicting UL parameters of a future UL transmission using an ML model according to some aspects. For example, a UE can determine UL parameters 1202 (e.g., SRI, TPMI, and/or MCS) for a future PUSCH using an ML model 1204. In some aspects, the ML model 1204 can be provided by the network, preconfigured (e.g., defined in a 3GPP specification), or based on specific UE implementation. In one aspect, the ML model 1204 used by the UE may be made known to the network entity (e.g., base station). In one aspect, the ML model can consider various inputs (e.g., ML-model inputs 1206) that can include one or more of the factors described above in relation to FIGS. 8-11. For example, the ML-model inputs 1206 can include at least the UL parameters (e.g., SRI and TPMI) for a future scheduled PUSCH (e.g., PUSCH 1108) associated with a future time instance. In some aspects, the ML model inputs and/or outputs can be standard predefined (e.g., defined in 3GPP specifications) or network configured (e.g., the UE can download the ML model from a network entity).

In some aspects, the ML model 1204 can be trained using a suitable method and data, for example, a sequence of UL parameters for associated future UL transmission instances that are determined via specific SRS measurements. In one example, the ML model 1204 can be trained with an input sequence of SRIs and TPMIs determined based on periodic SRS (e.g., with a periodicity of 5 milliseconds (ms)) measurements as well as DL measurements via periodic CSI-RS (e.g., with a periodicity of 5 ms). The outputs can be predicted SRIs and TPMIs for future (e.g., 5 ms) UL instances. In one example, periodic SRS can have a periodicity of 20 ms. The UE can receive an UL-grant DCI that indicates the predicted future SRI/TPMI targeting a future PUSCH scheduled by the current UL-grant DCI that can be determined by the network entity based on the periodic SRS transmitted before the UL-grant DCI. The UE may use the indicated SRIs/TPMIs as part of the ML-model input sequence, while the SRIs/TPMIs predicted by the ML-model can also be used as model inputs, to build the input sequence of SRIs/TPMIs with a periodicity (e.g., 5 ms). For a future PUSCH without SRI/TPMI being indicated by UL-grant DCI, the UE can determine the SRI/TPMI for the future PUSCH based on the ML predicted UL parameters associated with the corresponding PUSCH time instance.

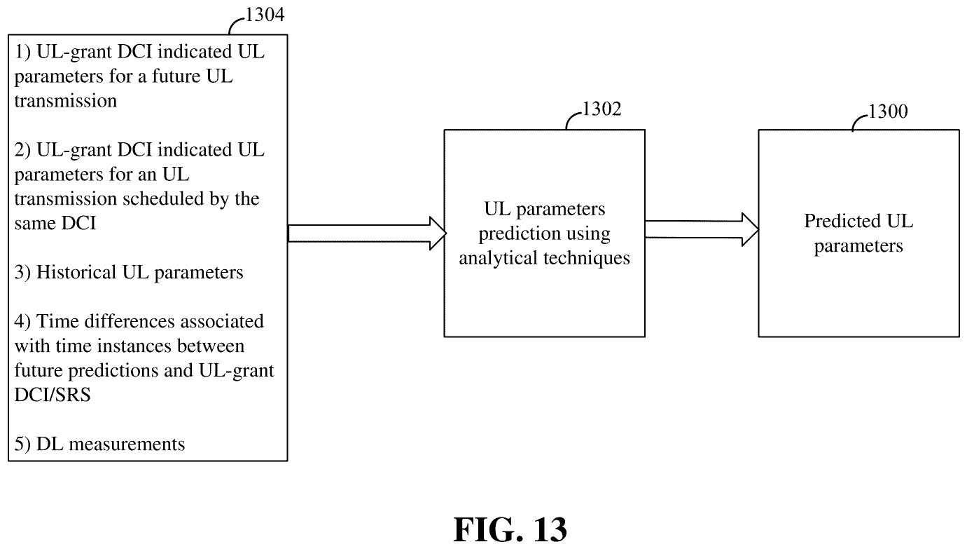

FIG. 13 is a diagram illustrating a process for predicting UL parameters of a future UL transmission using analytical techniques according to some aspects. The UE can determine predicted UL parameters 1300 (e.g., SRI and TPMI) for a future UL transmission (e.g., PUSCH) using certain analytical techniques 1302. In one aspect, the UE can consider one or more of the options described above in relation to FIGS. 8-11.

In one example, the UE can determine the predicted UL parameters using interpolation based on: 1) UL-grant DCI indicated predicted SRI/TPMI targeting a future PUSCH; 2) UL-grant DCI indicated SRI/TPMI targeting a PUSCH scheduled by the same UL-grant DCI; 3) a time difference between the scheduled time of the future PUSCH and the time receiving the UL-grant DCI (or the time transmitting the SRS associated with the indicated SRI/TPMI targeting the PUSCH scheduled by the UL-grant DCI); 4) a time difference between the scheduled time of the future PUSCH and the future time instance targeted by the predicted SRI/TPMI indicated in the UL-grant DCI; and 5) DL measurements.

In another example, the UE can determine the predicted UL parameters by first using extrapolation based on: 1) UL-grant DCI indicated predicted SRI/TPMI targeting a future PUSCH; 2) UL-grant DCI indicated SRI/TPMI targeting a PUSCH scheduled by the same UL-grant DCI; 3) a time difference between a time instance preceding the scheduled time of the future PUSCH but later than the time receiving the UL-grant DCI, and the time receiving the UL-grant DCI; and 4) DL measurements. Based on the extrapolation, the UE can determine the intermediate predicted SRI/TPMI. Then the UE can determine the predicted SRI/TPMI for a future PUSCH using interpolation based on 1) the intermediate predicted SRI/TPMI; 2) UL-grant DCI indicated predicted SRI/TPMI targeting a future PUSCH; 3) a time difference between the scheduled time of the future PUSCH and the time receiving the UL-grant DCI (or the time transmitting the SRS associated with the indicated SRI/TPMI targeting the PUSCH scheduled by the UL-grant DCI); 4) a time difference between the scheduled time of the future PUSCH and the future time instance targeted by the predicted SRI/TPMI indicated in the UL-grant DCI; 5) a time difference between a time instance preceding the scheduled time of the future PUSCH but later than the time receiving the UL-grant DCI, and the time receiving the UL-grant DCI; and 6) DL measurements.

In some aspects, the above described analytical techniques can be defined in a communication standard (e.g., 3GPP specifications), a network entity configuration, or based on UE-specific implementations. In some aspects, the analytical techniques can include interpolation and/or extrapolation. In some aspects, interpolation and/or extrapolation can be linear, polynomial, or kernel-based. In some aspects, the coefficients associated with the interpolation and/or extrapolation can be indicated by the UL-grant DCI or preconfigured.

In some aspects, the network entity may further configure DL reference signals (e.g., SSB and CSI-RS) for measuring DL channel characteristics associated with the determination of the predicted UL parameters (e.g., SRIs/TPMIs). In one example, the network entity (e.g., a gNB, a CU, etc.) can link DL reference signal (e.g., CSI-RS/SSB) resource setting, resource set, or resource ID(s), with the SRS resource set used for facilitating UL parameters prediction. In some aspects, the DL reference signal resource setting may be configured by an information element (IE) (e.g., CSI-ResourceConfig). For example, a CSI-ResourceConfig IE can configure one or more CSI resource sets or SSB resource sets. Additional information related to DL reference signals can also be configured by the CSI-ResourceConfig IE. In some aspects, the reference signal resource set may include set-specific configurations. Each DL reference signal resource can indicate the particular beam, frequency resource, and OFDM symbol on which the reference signal may be measured. Each reference signal resource may further be indexed by a respective reference signal resource ID. The reference signal resource ID may identify not only the particular beam, but also the resources on which the reference signal may be measured. For example, the reference signal resource ID may include a CSI-RS resource indicator (CRI) or an SRI. In one aspect, the network entity can use an RRC configuration (e.g., SRS-ResourceSet) to set the SRS usage type (e.g., PredictiveSRS type) of SRS resources for predicting UL parameters. In one example, the network entity can link a DL reference signal (e.g., CSI-RS/SSB) resource setting, resource set, or resource ID(s), with the ML model used for UL parameters prediction.

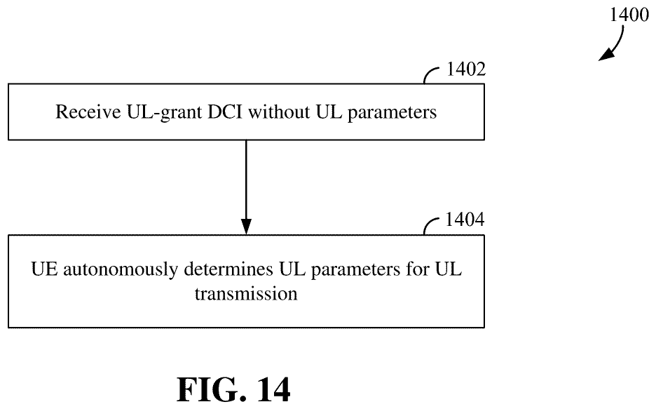

FIG. 14 is a flow chart illustrating a process 1400 of scheduling an UL transmission using DCI without an UL parameter indication according to some aspects. At block 1402, a UE can receive an UL-grant DCI from a network entity (e.g., a gNB). The UL-grant DCI can schedule a PUSCH without providing or indicating the corresponding UL parameters (e.g., SRI, TPMI, and/or MCS) for the UL transmission. At block 1404, the UE can autonomously determine the UL parameters (e.g., SRI, TPMI, and/or MCS) for the UL transmission (e.g., PUSCH) based on previously received UL parameters. In one example, the UE can apply the UL parameters identified in previous DCI(s)) to the future UL transmission scheduled by a configured grant (e.g., up uplink grant by RRC). In some aspects, the network entity can use a specific DCI format for the UL-grant DCI without indicating UL parameters. In one example, the DCI can be scrambled with a specific RNTI that indicates the UL-grant DCI without UL parameters.

In one aspect, in response to the network entity sending an UL-grant DCI without UL parameters, the UE can determine the UL parameters based on a previous UL-grant DCI that includes information for predicting future UL parameters. In one example, based on the previous UL-grant DCI, the UE can identify a time window for receiving UL-grant DCI scheduling PUSCH(s) without UL parameters. In one example, the network entity can use RRC signaling to preconfigure a number of time window choices, and the UL-grant DCI can indicate one of the windows.

In one aspect, a configured grant PUSCH configuration may indicate that the UL parameters can be the predicted UL parameters identified in previous proposals (e.g., UL-grant DCI with UL parameters for future UL transmissions). In this case, the UE does not expect the DCI (for triggering the configured grant PUSCH) to include UL parameters.

In some aspects, the UE can determine that no UL parameters (e.g., SRI, TPMI, and/or MCS) are explicitly indicated in an UL-grant DCI based on the DCI format used, and can then use predicted UL parameters based on previous proposals. The DCI can have a specific format or scrambled with a specific RNTI to indicate that the DCI does not explicitly indicate UL parameters.

In some aspects, the network entity (e.g., gNB) can initialize (start) and terminate (stop) using the above-described UL parameters prediction processes explicitly, for example, using DCI, MAC control element (MAC-CE), and/or RRC signaling. In some aspects, the network entity can implicitly indicate to the UE whether to start or stop using the above-described UL parameters prediction processes by using a specific DCI format or a DCI scrambled with a specific RNTI. In some aspects, the UE can assume that the predicted UL parameters are based on the same transmission rank identified from the UL-grant DCI that provides information for identifying the predicted UL parameters.

In some aspects, the UE can proactively or autonomously send a request or report (e.g., a scheduling request (SR), UCI, MAC CE, or RRC message) to indicate a request to stop using the above-described UL parameters prediction processes. In one example, the UE can determine that it is going to move faster, and UL parameters prediction may be less efficient or accurate. In that case, the UE can request the network entity to stop using the UL parameter prediction processes. In one example, the UE can predict that the channel condition is going to vary more rapidly based on DL measurements. In that case, the UE can request the network entity to stop using the UL parameters prediction processes.

In some aspects, the above-described UL parameters prediction processes can be used for time domain MCS prediction. In some aspects, the prediction of MCS and SRI/TPMI can be jointly used for UL transmissions. In some aspects, an ML model predicting future MCS can also take the future predicted SRIs/TPMIs as inputs for MCS prediction.

In some aspects, the future UL time instance associated with the UL-grant DCI indicated predictive UL parameters (e.g., SRI and TPMI) of a future PUSCH, can be based on at least one of a standard definition (e.g., 3GPP specifications), an RRC configuration, or indicated in the UL-grant DCI. For example, one or more available options (e.g., future time instances of PUSCH) can be predefined (e.g., in 3GPP specification or an RRC configuration), and the UL-grant DCI can indicate one of the options.

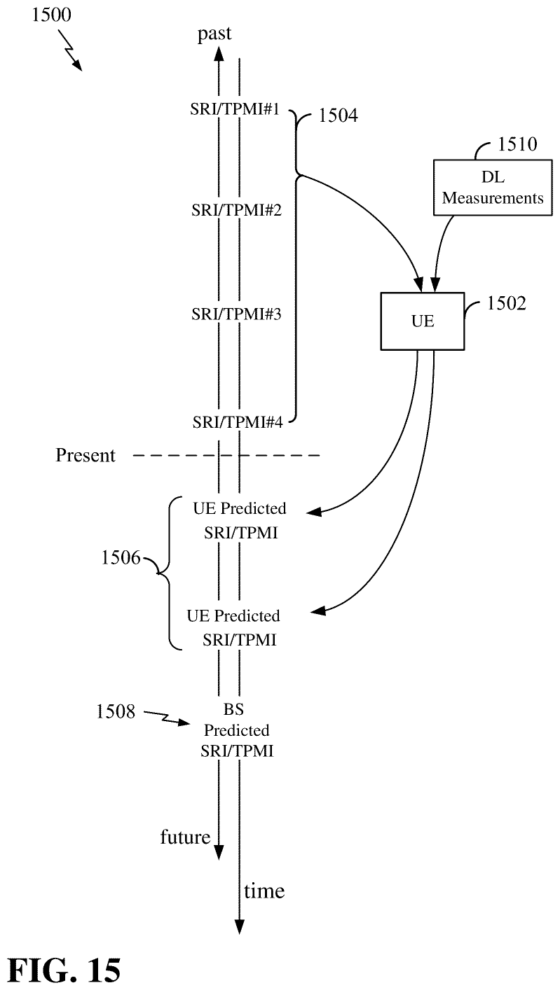

FIG. 15 is a diagram illustrating an exemplary timeline of UL parameters prediction 1500 at a UE according to some aspects. A UE 1502 can receive historical (past) UL parameters 1504 (e.g., SRI/TPMI #1, SRI/TPMI #2, SRI/TPMI #3, and SRI/TPMI #4) from a network entity (e.g., a base station). The UE can save these historical UL parameters 1504 at the UE. For future UL transmissions, the UE 1502 can predict future UL parameters 1506 (e.g., SRI/TPMI) based on the historical UL parameters 1504, BS predicted future UL parameters (e.g., e.g., BS predicted SRI/TPMI 1508), and DL measurements 1510. The BS predicted future UL parameters may have a course time resolution relative to the UE predicted UL parameters 1506. Accordingly, the UE can predict UL parameters for an UL transmission in a future time instance that is different from that of the BS predicted future UL parameters.

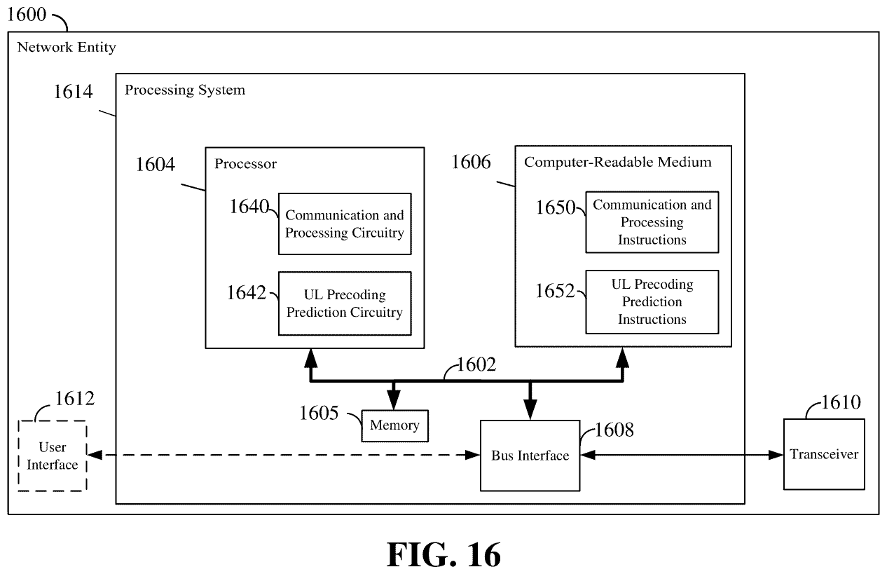

FIG. 16 is a block diagram illustrating an example of a hardware implementation for a network entity 1600 employing a processing system 1614. For example, the network entity 1600 may be a base station or scheduling entity as illustrated in any one or more of FIGS. 1, 2, 3, 6, and/or 7. The network entity 1600 may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC.

The network entity 1600 may be implemented with a processing system 1614 that includes one or more processors 1604. Examples of processors 1604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network entity 1600 may be configured to perform any one or more of the functions described herein. That is, the processor 1604, as utilized in a network entity 1600, may be used to implement any one or more of the processes and procedures described and illustrated in FIGS. 8-14 and 17.

The processor 1604 may in some instances be implemented via a baseband or modem chip and in other implementations, the processor 1604 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1614 may be implemented with a bus architecture, represented generally by the bus 1602. The bus 1602 may include any number of interconnecting buses and bridges depending on the specific application of the processing system 1614 and the overall design constraints. The bus 1602 communicatively couples together various circuits including one or more processors (represented generally by the processor 1604), a memory 1605, and computer-readable media (represented generally by the computer-readable medium 1606). The bus 1602 may also link various other circuits such as timing sources, peripherals, voltage regulators, and power management circuits, which are well known in the art, and therefore, will not be described any further. A bus interface 1608 provides an interface between the bus 1602 and a transceiver 1610. The transceiver 1610 provides a communication interface or means for communicating with various other apparatus over a transmission medium. Depending upon the nature of the apparatus, a user interface 1612 (e.g., keypad, display, speaker, microphone, joystick, touchscreen) may also be provided. Of course, such a user interface 1612 is optional, and may be omitted in some examples, such as a base station.

The processor 1604 is responsible for managing the bus 1602 and general processing, including the execution of software stored on the computer-readable medium 1606. The software, when executed by the processor 1604, causes the processing system 1614 to perform the various functions described below for any particular apparatus. The computer-readable medium 1606 and the memory 1605 may also be used for storing data that is manipulated by the processor 1604 when executing software.

One or more processors 1604 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1606. The computer-readable medium 1606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1606 may reside in the processing system 1614, external to the processing system 1614, or distributed across multiple entities including the processing system 1614. The computer-readable medium 1606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 1604 may include circuitry configured for various functions, including, for example, UL precoding prediction and indication. For example, the circuitry may be configured to implement one or more of the functions described in relation to FIGS. 8-14 and 17.

In some aspects of the disclosure, the processor 1604 may include communication and processing circuitry 1640 configured for various functions, including for example communicating with a network core (e.g., a 5G core network), scheduled entities (e.g., UE), or any other entity, such as, for example, local infrastructure or an entity communicating with the network entity 1600 via the Internet, such as a network provider. In some examples, the communication and processing circuitry 1640 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1640 may include one or more transmit/receive chains. In addition, the communication and processing circuitry 1640 may be configured to receive and process uplink traffic and uplink control messages (e.g., similar to uplink traffic 116 and uplink control 118 of FIG. 1), transmit and process downlink traffic and downlink control messages (e.g., similar to downlink traffic 112 and downlink control 114). The communication and processing circuitry 1640 may further be configured to execute communication and processing software 1650 stored on the computer-readable medium 1606 to implement one or more functions described herein.

In some implementations where the communication involves receiving information, the communication and processing circuitry 1640 may obtain information from a component of the network entity 1600 (e.g., from the transceiver 1610 that receives the information via radio frequency signaling or some other type of signaling suitable for the applicable communication medium), process (e.g., decode) the information, and output the processed information. For example, the communication and processing circuitry 1640 may output the information to another component of the processor 1604, to the memory 1605, or to the bus interface 1608. In some examples, the communication and processing circuitry 1640 may receive one or more of signals, messages, other information, or any combination thereof. In some examples, the communication and processing circuitry 1640 may receive information via one or more channels. In some examples, the communication and processing circuitry 1640 may include functionality for a means for receiving. In some examples, the communication and processing circuitry 1640 may include functionality for a means for processing, including a means for demodulating, a means for decoding, etc.

In some implementations where the communication involves sending (e.g., transmitting) information, the communication and processing circuitry 1640 may obtain information (e.g., from another component of the processor 1604, the memory 1605, or the bus interface 1608), process (e.g., modulate, encode, etc.) the information, and output the processed information. For example, the communication and processing circuitry 1640 may output the information to the transceiver 1610 (e.g., that transmits the information via radio frequency signaling or some other type of signaling suitable for the applicable communication medium). In some examples, the communication and processing circuitry 1640 may send one or more of signals, messages, other information, or any combination thereof. In some examples, the communication and processing circuitry 1640 may send information via one or more channels. In some examples, the communication and processing circuitry 1640 may include functionality for a means for sending (e.g., a means for transmitting). In some examples, the communication and processing circuitry 1640 may include functionality for a means for generating, including a means for modulating, a means for encoding, etc.

In some aspects of the disclosure, the processor 1604 may include UL precoding prediction circuitry 1642 configured for various functions, including for example, predicting UL parameters for future UL transmissions. In one aspect, the UL precoding prediction circuitry 1642 can be configured to determine the SRI, TPMI, and/or MCS of a future UL transmission. For example, the UL precoding prediction circuitry 1642 can be configured to predict the SRI, TPMI, and/or MCS of a future PUSCH using the processes and procedures described herein. In some examples, the UL precoding prediction circuitry 1642 may further be configured to execute UL precoding prediction software 1652 stored on the computer-readable medium 1606 to implement one or more functions described herein.

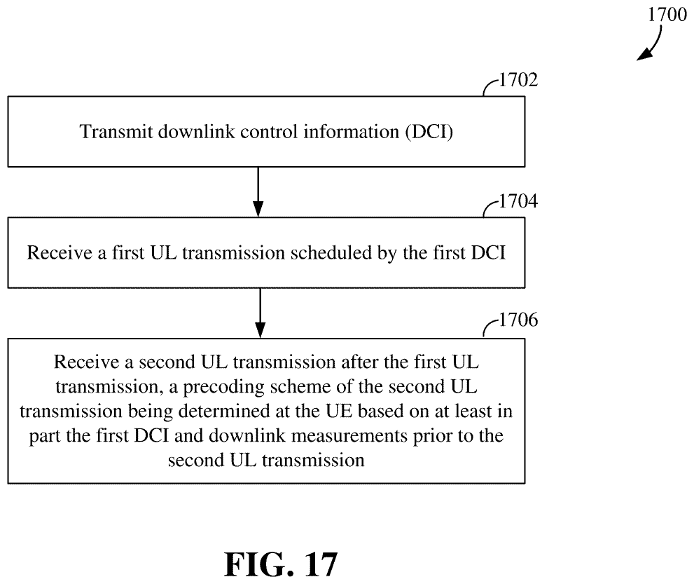

FIG. 17 is a flow chart illustrating an exemplary process 1700 for UL precoding scheme prediction in accordance with some aspects. As described below, some or all illustrated features may be omitted in a particular implementation within the scope of the present disclosure, and some illustrated features may not be required for the implementation of all examples. In some examples, the process 1700 may be carried out by the network entity 1600 illustrated in FIG. 16. In some examples, the process 1700 may be carried out by any suitable apparatus or means for carrying out the functions or algorithm described below.

At block 1702, a network entity can transmit a DCI (first DCI) to a UE. For example, the network entity can be a base station or scheduling entity described above in relation to FIGS. 1, 2, 3, 6, and/or 7. In one example, the communication and processing circuitry 1640 can provide a means to transmit the DCI to a UE using the transceiver 1610. In one example, the DCI may be similar to the DCI 1000 that can provide UL parameters 1002 for an UL transmission (e.g., PUSCH 1106 of FIG. 11) scheduled by the first DCI. The first DCI also can provide predicted UL parameters 1004 for a first instance of future UL transmission (e.g., PUSCH 1108 of FIG. 11). For example, the UL precoding prediction circuitry 1642 can provide a means to determine the predicted UL parameters usable in a precoding scheme (e.g., SRI, TPMI, and/or MCS) of the future UL transmission.

At block 1704, the network entity can receive a first UL transmission scheduled by the first DCI. For example, the communication and processing circuitry 1640 can provide a means to receive the first UL transmission (e.g., a PUSCH scheduled by the DCI) using the transceiver 1610. For example, the first UL transmission can use a precoding scheme (e.g., SRI, TPMI, and/or MCS) indicated in the first DCI.

At block 1706, the network entity can receive a second UL transmission after the first UL transmission. The second UL transmission is not scheduled by the first DCI. For example, the communication and processing circuitry 1640 can provide a means to receive the second UL transmission (e.g., PUSCH 1102 of FIG. 11) using the transceiver 1610. The second UL transmission can occur before the instance of future UL transmission (e.g., PUSCH 1108 of FIG. 11) associated with the predicted UL parameters 1004 included in the first DCI.

A precoding scheme of the second UL transmission can be determined at the UE based on at least in part the first DCI and downlink measurements (e.g., L1 measurements of SSB and/or CSI-RS) prior to the second UL transmission. In some aspects, the UE can autonomously determine the precoding scheme (e.g., SRI, TPMI, and/or MCS) based on one or more factors. A first factor is the precoding information associated with the first UL transmission that is scheduled by the first DCI. A second factor is the predicted precoding information (e.g., BS predicted UL parameters 1004) associated with a potential UL transmission at a time instance after the second UL transmission. A third factor is historical uplink precoding information transmitted by the network entity. A fourth factor is a time difference between a time instance associated with the second UL transmission and a reception time of the first DCI. A fifth factor is a time difference between a time instance associated with the second UL transmission and a time instance associated with predicted UL transmission.

In one configuration, the network entity 1600 includes means for performing the above-described UL precoding scheme prediction processes. In one aspect, the aforementioned means may be the processor 1604 shown in FIG. 16 configured to perform the functions recited by the aforementioned means. In another aspect, the aforementioned means may be a circuit or any apparatus configured to perform the functions recited by the aforementioned means.

Of course, in the above examples, the circuitry included in the processor 1604 is merely provided as an example, and other means for carrying out the described functions may be included within various aspects of the present disclosure, including but not limited to the instructions stored in the computer-readable storage medium 1606, or any other suitable apparatus or means described in any one of the FIGS. 1, 2, 3, 6, and/or 7, and utilizing, for example, the processes and/or algorithms described herein in relation to FIGS. 8-14 and/or 17.

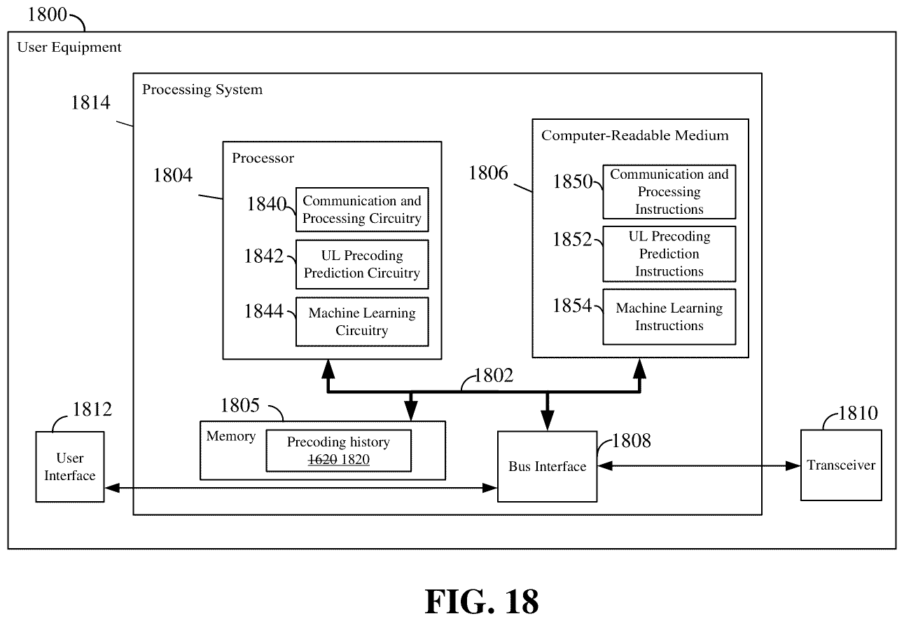

FIG. 18 is a diagram illustrating an example of a hardware implementation for an exemplary UE 1800 employing a processing system 1814. In accordance with various aspects of the disclosure, an element, or any portion of an element, or any combination of elements may be implemented with a processing system 1814 that includes one or more processors 1804. For example, the UE 1800 may be a UE or scheduled entity as illustrated in any one or more of FIGS. 1, 2, 3, 5, and/or 6.

The processing system 1814 may be substantially the same as the processing system 1614 illustrated in FIG. 16, including a bus interface 1808, a bus 1802, memory 1805, a processor 1804, and a computer-readable medium 1806. Furthermore, the UE 1800 may include a user interface 1812 and a transceiver 1810 substantially similar to those described above in FIG. 16. That is, the processor 1804, as utilized in the UE 1800, may be used to implement any one or more of the processes described and illustrated in FIGS. 8-14 and 19.

In some aspects of the disclosure, the processor 1804 may include circuitry configured for various functions, including, for example, UL precoding scheme prediction. For example, the circuitry may be configured to implement one or more of the functions described in relation to FIGS. 8-14 and 19.

In some aspects of the disclosure, the processor 1804 may include communication and processing circuitry 1840 configured for various functions, including for example communicating with a network entity (e.g., a base station, gNB, CU, or DU). In some examples, the communication and processing circuitry 1840 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1840 may include one or more transmit/receive chains. In addition, the communication and processing circuitry 1840 may be configured to transmit and process uplink traffic and uplink control messages (e.g., similar to uplink traffic 116 and uplink control 118 of FIG. 1), receive and process downlink traffic and downlink control messages (e.g., similar to downlink traffic 112 and downlink control 114). The communication and processing circuitry 1840 may further be configured to execute communication and processing software 1750 stored on the computer-readable medium 1806 to implement one or more functions described herein.

In some implementations where the communication involves receiving information, the communication and processing circuitry 1840 may obtain information from a component of the UE 1800 (e.g., from the transceiver 1810 that receives the information via radio frequency signaling or some other type of signaling suitable for the applicable communication medium), process (e.g., decode) the information, and output the processed information. For example, the communication and processing circuitry 1840 may output the information to another component of the processor 1804, to the memory 1805, or to the bus interface 1808. In some examples, the communication and processing circuitry 1840 may receive one or more of signals, messages, other information, or any combination thereof. In some examples, the communication and processing circuitry 1840 may receive information via one or more channels. In some examples, the communication and processing circuitry 1840 may include functionality for a means for receiving. In some examples, the communication and processing circuitry 1840 may include functionality for a means for processing, including a means for demodulating, a means for decoding, etc.

In some implementations where the communication involves sending (e.g., transmitting) information, the communication and processing circuitry 1840 may obtain information (e.g., from another component of the processor 1804, the memory 1805, or the bus interface 1808), process (e.g., modulate, encode, etc.) the information, and output the processed information. For example, the communication and processing circuitry 1840 may output the information to the transceiver 1810 (e.g., that transmits the information via radio frequency signaling or some other type of signaling suitable for the applicable communication medium). In some examples, the communication and processing circuitry 1840 may send one or more of signals, messages, other information, or any combination thereof. In some examples, the communication and processing circuitry 1840 may send information via one or more channels. In some examples, the communication and processing circuitry 1840 may include functionality for a means for sending (e.g., a means for transmitting). In some examples, the communication and processing circuitry 1840 may include functionality for a means for generating, including a means for modulating, a means for encoding, etc.

In some aspects of the disclosure, the processor 1804 may include UL precoding prediction circuitry 1842 configured for various functions, including for example, predicting UL parameters for use in a precoding scheme of an UL transmission. For example, the UL precoding prediction circuitry 1842 can be configured to determine or predict the SRI, TPMI, and/or MCS of a future UL transmission. For example, the UL precoding prediction circuitry 1842 can be configured to predict SRI, TPMI, and/or MCS of a future PUSCH using the processes and procedures described herein.

In one aspect, the UL precoding prediction circuitry 1842 can be configured to determine the precoding scheme based on at least one of: 1) precoding information associated with an UL transmission scheduled by a DCI; 2) historical uplink precoding information received from a network entity; 3) a time difference between a time instance associated with an UL transmission and a reception time of a DCI; 4) a time difference between a time instance associated with an UL transmission and a time instance associated with predicted UL transmission; and 5) downlink measurements. In one aspect, the UE can store historical uplink precoding information (e.g., precoding history 1820) in the memory 1805. In some examples, the UL precoding prediction circuitry 1842 may further be configured to execute UL precoding scheme prediction software 1852 stored on the computer-readable medium 1806 to implement one or more functions described herein.

In some aspects of the disclosure, the processor 1804 may include machine learning circuitry 1844 configured for various functions, for example, ML techniques for processing data and information. In some examples, the machine learning circuitry 1844 may be configured to execute machine learning software 1854 stored on the computer-readable medium 1806 to implement one or more functions described herein. In one aspect, the machine learning circuitry 1844 can be configured to implement any of the ML techniques described herein for predicting UL parameters or precoding scheme for an UL transmission.

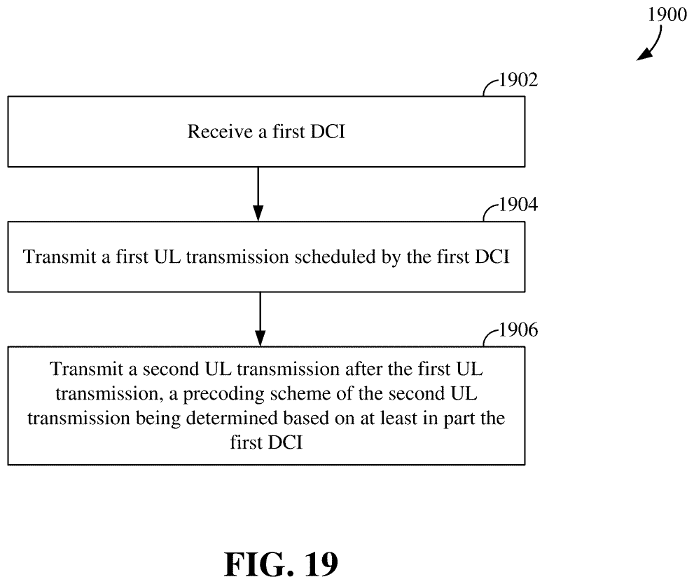

FIG. 19 is a flow chart illustrating an exemplary process 1900 for UL precoding scheme prediction in accordance with some aspects. As described below, some or all illustrated features may be omitted in a particular implementation within the scope of the present disclosure, and some illustrated features may not be required for the implementation of all examples. In some examples, the process 1900 may be carried out by the UE 1800 illustrated in FIG. 18. In some examples, the process 1900 may be carried out by any suitable apparatus or means for carrying out the functions or algorithm described below.

At block 1902, a UE can receive a first DCI from a network entity (e.g., a base station, gNB). For example, the UE can be one of the UEs or scheduled entities described above in relation to FIGS. 1, 2, 3, 6, and/or 7. In one example, the communication and processing circuitry 1840 can provide a means to receive the DCI using the transceiver 1810. In one example, the DCI may be the DCI 1000 that provides UL parameters 1002 for an UL transmission (e.g., PUSCH 1106 of FIG. 11) scheduled by the first DCI. The first DCI also can provide predicted UL parameters 1004 for a first instance of future UL transmission (e.g., PUSCH 1108 of FIG. 11).

At block 1904, the UE can transmit a first UL transmission scheduled by the first DCI. For example, the communication and processing circuitry 1840 can provide a means to transmit the first UL transmission (e.g., PUSCH) using the transceiver 1810. For example, the UE can transmit the first UL transmission using a precoding scheme (e.g., SRI, TPMI, and/or MCS) indicated in the first DCI.

At block 1906, the UE can transmit a second UL transmission after the first UL transmission. The second UL transmission is not scheduled by the first DCI. For example, the communication and processing circuitry 1940 can provide a means to transmit the second UL transmission (e.g., PUSCH 1102 of FIG. 11) using the transceiver 1810. The UL precoding prediction circuitry can provide a means to determine a precoding scheme of the second UL transmission based on at least in part the first DCI, downlink measurements (e.g., L1 measurements of SSB and/or CSI-RS) prior to the second UL transmission, and historical precoding information. In some aspects, the precoding scheme (e.g., SRI, TPMI, and/or MCS) can be based on one or more factors. A first factor is precoding information associated with the first UL transmission scheduled by the first DCI. A second factor is predicted precoding information associated with a potential UL transmission at a time instance after the second UL transmission. A third factor is historical uplink precoding information (e.g., precoding history 1820) transmitted by the network entity. A fourth factor is a time difference between a time instance associated with the second UL transmission and a reception time of the first DCI. A fifth factor is a time difference between a time instance associated with the second UL transmission and a time instance associated with predicted UL transmission.

In one aspect, the UL precoding prediction circuitry 1842 can provide a means to determine the predicted UL parameters of the second UL transmission. In one example, the precoding prediction circuitry 1842 can use the machine learning circuitry 1844 to determine the predicted UL parameters using ML techniques described herein. In one example, the precoding prediction circuitry 1842 can determine the predicted UL parameters using the analytical techniques described herein.

In one configuration, the UE 1800 includes means for performing UL precoding scheme prediction processes. In one aspect, the aforementioned means may be the processor 1804 shown in FIG. 18 configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1, 2, 3, 6, and/or 7, and utilizing, for example, the processes and/or algorithms described herein in relation to FIGS. 8-14 and/or 19.

In a first aspect, a method of wireless communication at a UE is disclosed. The method comprises: receiving, from a network entity, a first downlink control information (DCI); transmitting a first uplink (UL) transmission scheduled by the first DCI; and transmitting a second UL transmission after the first UL transmission, a precoding scheme of the second UL transmission being determined based on at least in part the first DCI.

In a second aspect, alone or in combination with the first aspect, the method further comprises: determining the precoding scheme based on at least in part predicted precoding information associated with a potential UL transmission at a time instance after the second UL transmission.

In a third aspect, alone or in combination with any of the first to second aspects, wherein the determining the precoding scheme further comprises determining the precoding scheme based on at least one of: precoding information associated with the first UL transmission scheduled by the first DCI; historical uplink precoding information received from the network entity; a time difference between a time instance associated with the second UL transmission and a reception time of the first DCI; a time difference between a time instance associated with the second UL transmission and a time instance associated with predicted UL transmission; or downlink measurements.

In a fourth aspect, alone or in combination with the first aspect, the method further comprises: determining the precoding scheme using a machine learning (ML) model, an input of the ML model comprising at least one of: predicted precoding information associated with a potential UL transmission at a time instance after the second UL transmission; precoding information associated with the first UL transmission scheduled by the first DCI; historical uplink precoding information received from the network entity; a time difference between a time instance associated with the second UL transmission and a reception time of the first DCI; a time difference between a time instance associated with the second UL transmission and a time instance associated with predicted UL transmission; or downlink measurements.

In a fifth aspect, alone or in combination with the first aspect, the method further comprises determining the precoding scheme using at least one of interpolation or extrapolation, based on at least one of: predicted precoding information associated with a potential UL transmission at a time instance after the second UL transmission; precoding information associated with the first UL transmission scheduled by the first DCI; historical uplink precoding information received from the network entity; a time difference between a time instance associated with the second UL transmission and a reception time of the first DCI; a time difference between a time instance associated with the second UL transmission and a time instance associated with predicted UL transmission; or downlink measurements.

In a sixth aspect, alone or in combination with the first aspect, the method further comprises determining the precoding scheme based on at least in part predicted precoding information included in the first DCI and downlink measurements obtained before the second UL transmission.

In a seventh aspect, alone or in combination with any of the first, second, fourth, fifth, and sixth aspects, the method further comprises: receiving a second DCI scheduling the second UL transmission; and determining the precoding scheme of the second UL transmission without relying on information provided by the second DCI.

In an eighth aspect, alone or in combination with any of the first, second, fourth, fifth, and sixth aspects, wherein the precoding scheme comprises at least one of SRS resource indicator, transmit precoder matrix indicator, or modulation and coding scheme MCS.

In a ninth aspect, alone or in combination with any of the first, second, fourth, fifth, and sixth aspects, the method further comprises at least one of: transmitting, to the network entity, a request to stop a process for predicting the precoding scheme; or receiving, from the network entity, a command to start or stop the process for predicting the precoding scheme.

In a tenth aspect, a user equipment (UE) for wireless communication is disclosed. The UE includes a transceiver for wireless communication; a memory; and a processor coupled to the transceiver and the memory. The processor and the memory are configured to: receive, via the transceiver, a first downlink control information (DCI); transmit, via the transceiver, a first uplink (UL) transmission scheduled by the first DCI; and transmit, via the transceiver, a second UL transmission after the first UL transmission, a precoding scheme of the second UL transmission being determined based on at least in part the first DCI.

In an eleventh aspect, alone or in combination with the tenth aspect, wherein the processor and the memory are further configured to: determine the precoding scheme based on at least in part predicted precoding information associated with a potential UL transmission at a time instance after the second UL transmission.

In a twelfth aspect, alone or in combination with any of the tenth to eleventh aspects, wherein the processor and the memory are further configured to determine the precoding scheme based on at least one of: precoding information associated with the first UL transmission scheduled by the first DCI; historical uplink precoding information received from a network entity; a time difference between a time instance associated with the second UL transmission and a reception time of the first DCI; a time difference between a time instance associated with the second UL transmission and a time instance associated with predicted UL transmission; or downlink measurements.

In a thirteenth aspect, alone or in combination with the tenth aspect, wherein the processor and the memory are further configured to determine the precoding scheme using a machine learning (ML) model, an input of the ML model comprising at least one of: predicted precoding information associated with a potential UL transmission at a time instance after the second UL transmission; precoding information associated with the first UL transmission scheduled by the first DCI; historical uplink precoding information received from a network entity; a time difference between a time instance associated with the second UL transmission and a reception time of the first DCI; a time difference between a time instance associated with the second UL transmission and a time instance associated with predicted UL transmission; or downlink measurements.

In a fourteenth aspect, alone or in combination with the tenth aspect, wherein the processor and the memory are further configured to determine the precoding scheme using at least one of interpolation or extrapolation, based on at least one of: predicted precoding information associated with a potential UL transmission at a time instance after the second UL transmission; precoding information associated with the first UL transmission scheduled by the first DCI; historical uplink precoding information received from a network entity; a time difference between a time instance associated with the second UL transmission and a reception time of the first DCI; a time difference between a time instance associated with the second UL transmission and a time instance associated with predicted UL transmission; or downlink measurements.

In a fifteenth aspect, alone or in combination with the tenth aspect, wherein the processor and the memory are further configured to determine the precoding scheme based on at least in part predicted precoding information included in the first DCI and downlink measurements obtained before the second UL transmission.

In a sixteenth aspect, alone or in combination with any of the tenth, eleventh, thirteenth, fourteenth, and fifteenth aspects, wherein the processor and the memory are further configured to: receive a second DCI configured to schedule the second UL transmission; and determine the precoding scheme of the second UL transmission without relying on information provided by the second DCI.

In a seventeenth aspect, alone or in combination with any of the tenth, eleventh, thirteenth, fourteenth, and fifteenth aspects, wherein the precoding scheme comprises at least one of SRS resource indicator, transmit precoder matrix indicator, or modulation and coding scheme.

In an eighteenth aspect, alone or in combination with any of the tenth, eleventh, thirteenth, fourteenth, and fifteenth aspects, wherein the processor and the memory are further configured to, at least one of: transmit a request to stop a process for predicting the precoding scheme; or receive a command to start or stop the process for predicting the precoding scheme.

In a nineteenth aspect, a method of wireless communication at a network entity is disclosed. The method includes: transmitting a first downlink control information (DCI); receiving a first uplink (UL) transmission scheduled by the first DCI; and receiving a second UL transmission after the first UL transmission, a precoding scheme of the second UL transmission being determined at a user equipment (UE) based on at least in part the first DCI and downlink measurements prior to the second UL transmission.

In a twentieth aspect, alone or in combination with the nineteenth aspect, wherein the precoding scheme is based on at least one of: precoding information associated with the first UL transmission scheduled by the first DCI; predicted precoding information associated with a potential UL transmission at a time instance after the second UL transmission; historical uplink precoding information transmitted by the network entity; a time difference between a time instance associated with the second UL transmission and a reception time of the first DCI; or a time difference between a time instance associated with the second UL transmission and a time instance associated with predicted UL transmission.

In a twenty-first aspect, alone or in combination with any of the nineteenth and twentieth aspects, the method further comprises transmitting a second DCI scheduling the second UL transmission without providing information in the second DCI for determining the precoding scheme of the second UL transmission.

In a twenty-second aspect, alone or in combination with any of the nineteenth and twentieth aspects, wherein the precoding scheme comprises at least one of SRS resource indicator, transmit precoder matrix indicator, or modulation and coding scheme.

In a twenty-third aspect, alone or in combination with any of the nineteenth and twentieth aspects, the method further comprises at least one of: receiving a request to stop a process for predicting the precoding scheme; or transmitting a command to start or stop the process for predicting the precoding scheme.

In a twenty-fourth aspect, alone or in combination with any of the nineteenth and twentieth aspects, the method further comprises at least one of: transmitting information on an association between a downlink reference signal resource and an uplink reference signal resource for predicting the precoding scheme; or transmitting information on an association between a downlink reference signal resource and a machine learning model configured for predicting the precoding scheme.

In a twenty-fifth aspect, a network entity for a communication network is disclosed. The network entity comprises a memory and a processor coupled to the memory. The processor and the memory are configured to: transmit a first downlink control information (DCI); receive a first uplink (UL) transmission scheduled by the first DCI; and receive a second UL transmission after the first UL transmission, a precoding scheme of the second UL transmission being determined at a user equipment (UE) based on at least in part the first DCI and downlink measurements prior to the second UL transmission.

In a twenty-sixth aspect, alone or in combination with the twenty-fifth aspect, wherein the precoding scheme is based on at least one of: precoding information associated with the first UL transmission scheduled by the first DCI; predicted precoding information associated with a potential UL transmission at a time instance after the second UL transmission; historical uplink precoding information transmitted by the network entity; a time difference between a time instance associated with the second UL transmission and a reception time of the first DCI; or a time difference between a time instance associated with the second UL transmission and a time instance associated with predicted UL transmission.

In a twenty-seventh aspect, alone or in combination with any of the twenty-fifth and twenty-sixth aspects, wherein the processor and the memory are further configured to: transmit a second DCI configured to schedule the second UL transmission without providing information in the second DCI for determining the precoding scheme of the second UL transmission.

In a twenty-eighth aspect, alone or in combination with any of the twenty-fifth and twenty-sixth aspects, wherein the precoding scheme comprises at least one of SRS resource indicator, transmit precoder matrix indicator, or modulation and coding scheme.

In a twenty-ninth aspect, alone or in combination with any of the twenty-fifth and twenty-sixth aspects, wherein the processor and the memory are further configured to, at least one of: receive a request to stop a process for predicting the precoding scheme; or transmit a command to start or stop the process for predicting the precoding scheme.

In a thirtieth aspect, alone or in combination with any of the twenty-fifth and twenty-sixth aspects, wherein the processor and the memory are configured to, at least one of: transmit information on an association between a downlink reference signal resource and an uplink reference signal resource for predicting the precoding scheme; or transmit information on an association between a downlink reference signal resource and a machine learning model configured for predicting the precoding scheme.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-19 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-19 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication at a user equipment (UE), comprising:
receiving, from a network entity, a first downlink control information (DCI);
transmitting a first uplink (UL) transmission scheduled by the first DCI; and
transmitting a second UL transmission after the first UL transmission, a precoding scheme of the second UL transmission being determined based on at least in part the first DCI.

2. The method of claim 1, further comprising:
determining the precoding scheme based on at least in part predicted precoding information associated with a potential UL transmission at a time instance after the second UL transmission.

3. The method of claim 2, wherein the determining the precoding scheme further comprises determining the precoding scheme based on at least one of:
precoding information associated with the first UL transmission scheduled by the first DCI;
historical uplink precoding information received from the network entity;
a time difference between a time instance associated with the second UL transmission and a reception time of the first DCI;
a time difference between a time instance associated with the second UL transmission and a time instance associated with predicted UL transmission; or
downlink measurements.

4. The method of claim 1, further comprising:
determining the precoding scheme using a machine learning (ML) model, an input of the ML model comprising at least one of:
predicted precoding information associated with a potential UL transmission at a time instance after the second UL transmission;
precoding information associated with the first UL transmission scheduled by the first DCI;
historical uplink precoding information received from the network entity;
a time difference between a time instance associated with the second UL transmission and a reception time of the first DCI;
a time difference between a time instance associated with the second UL transmission and a time instance associated with predicted UL transmission; or
downlink measurements.

5. The method of claim 1, further comprising:
determining the precoding scheme using at least one of interpolation or extrapolation, based on at least one of:
predicted precoding information associated with a potential UL transmission at a time instance after the second UL transmission;
precoding information associated with the first UL transmission scheduled by the first DCI;
historical uplink precoding information received from the network entity;
a time difference between a time instance associated with the second UL transmission and a reception time of the first DCI;
a time difference between a time instance associated with the second UL transmission and a time instance associated with predicted UL transmission; or
downlink measurements.

6. The method of claim 1, further comprising:
determining the precoding scheme based on at least in part predicted precoding information included in the first DCI and downlink measurements obtained before the second UL transmission.

7. The method of claim 1, further comprising:
receiving a second DCI scheduling the second UL transmission; and
determining the precoding scheme of the second UL transmission without relying on information provided by the second DCI.

8. The method of claim 1, wherein the precoding scheme comprises at least one of SRS resource indicator, transmit precoder matrix indicator, or modulation and coding scheme MCS.

9. The method of claim 1, further comprising at least one of:
transmitting, to the network entity, a request to stop a process for predicting the precoding scheme; or
receiving, from the network entity, a command to start or stop the process for predicting the precoding scheme.

10. A user equipment (UE) for wireless communication, comprising:
a transceiver for wireless communication;
a memory; and
a processor coupled to the transceiver and the memory,
wherein the processor and the memory are configured to:
receive, via the transceiver, a first downlink control information (DCI);
transmit, via the transceiver, a first uplink (UL) transmission scheduled by the first DCI; and
transmit, via the transceiver, a second UL transmission after the first UL transmission, a precoding scheme of the second UL transmission being determined based on at least in part the first DCI.

11. The UE of claim 10, wherein the processor and the memory are further configured to:
determine the precoding scheme based on at least in part predicted precoding information associated with a potential UL transmission at a time instance after the second UL transmission.

12. The UE of claim 11, wherein the processor and the memory are further configured to determine the precoding scheme based on at least one of:
precoding information associated with the first UL transmission scheduled by the first DCI;
historical uplink precoding information received from a network entity;
a time difference between a time instance associated with the second UL transmission and a reception time of the first DCI;
a time difference between a time instance associated with the second UL transmission and a time instance associated with predicted UL transmission; or
downlink measurements.

13. The UE of claim 10, wherein the processor and the memory are further configured to:
determine the precoding scheme using a machine learning (ML) model, an input of the ML model comprising at least one of:
predicted precoding information associated with a potential UL transmission at a time instance after the second UL transmission;
precoding information associated with the first UL transmission scheduled by the first DCI;
historical uplink precoding information received from a network entity;
a time difference between a time instance associated with the second UL transmission and a reception time of the first DCI;
a time difference between a time instance associated with the second UL transmission and a time instance associated with predicted UL transmission; or
downlink measurements.

14. The UE of claim 10, wherein the processor and the memory are further configured to:
determine the precoding scheme using at least one of interpolation or extrapolation, based on at least one of:
predicted precoding information associated with a potential UL transmission at a time instance after the second UL transmission;
precoding information associated with the first UL transmission scheduled by the first DCI;
historical uplink precoding information received from a network entity;
a time difference between a time instance associated with the second UL transmission and a reception time of the first DCI;
a time difference between a time instance associated with the second UL transmission and a time instance associated with predicted UL transmission; or
downlink measurements.

15. The UE of claim 10, wherein the processor and the memory are further configured to:
determine the precoding scheme based on at least in part predicted precoding information included in the first DCI and downlink measurements obtained before the second UL transmission.

16. The UE of claim 10, wherein the processor and the memory are further configured to:
receive a second DCI configured to schedule the second UL transmission; and
determine the precoding scheme of the second UL transmission without relying on information provided by the second DCI.

17. The UE of claim 10, wherein the precoding scheme comprises at least one of SRS resource indicator, transmit precoder matrix indicator, or modulation and coding scheme.

18. The UE of claim 10, wherein the processor and the memory are further configured to, at least one of:
transmit a request to stop a process for predicting the precoding scheme; or
receive a command to start or stop the process for predicting the precoding scheme.

19. A method of wireless communication at a network entity, comprising:
transmitting a first downlink control information (DCI);
receiving a first uplink (UL) transmission scheduled by the first DCI; and
receiving a second UL transmission after the first UL transmission, a precoding scheme of the second UL transmission being determined at a user equipment (UE) based on at least in part the first DCI and downlink measurements prior to the second UL transmission.

20. The method of claim 19, wherein the precoding scheme is based on at least one of:
precoding information associated with the first UL transmission scheduled by the first DCI;
predicted precoding information associated with a potential UL transmission at a time instance after the second UL transmission;
historical uplink precoding information transmitted by the network entity;
a time difference between a time instance associated with the second UL transmission and a reception time of the first DCI; or
a time difference between a time instance associated with the second UL transmission and a time instance associated with predicted UL transmission.

21. The method of claim 19, further comprising:
transmitting a second DCI scheduling the second UL transmission without providing information in the second DCI for determining the precoding scheme of the second UL transmission.

22. The method of claim 19, wherein the precoding scheme comprises at least one of SRS resource indicator, transmit precoder matrix indicator, or modulation and coding scheme.

23. The method of claim 19, further comprising at least one of:
receiving a request to stop a process for predicting the precoding scheme; or
transmitting a command to start or stop the process for predicting the precoding scheme.

24. The method of claim 19, further comprising at least one of:
transmitting information on an association between a downlink reference signal resource and an uplink reference signal resource for predicting the precoding scheme; or
transmitting information on an association between a downlink reference signal resource and a machine learning model configured for predicting the precoding scheme.

25. A network entity for a communication network, comprising:
a memory; and
a processor coupled to the memory, wherein the processor and the memory are configured to:
transmit a first downlink control information (DCI);
receive a first uplink (UL) transmission scheduled by the first DCI; and
receive a second UL transmission after the first UL transmission, a precoding scheme of the second UL transmission being determined at a user equipment (UE) based on at least in part the first DCI and downlink measurements prior to the second UL transmission.

26. The network entity of claim 25, wherein the precoding scheme is based on at least one of:
precoding information associated with the first UL transmission scheduled by the first DCI;
predicted precoding information associated with a potential UL transmission at a time instance after the second UL transmission;
historical uplink precoding information transmitted by the network entity;
a time difference between a time instance associated with the second UL transmission and a reception time of the first DCI; or
a time difference between a time instance associated with the second UL transmission and a time instance associated with predicted UL transmission.

27. The network entity of claim 25, wherein the processor and the memory are further configured to:
transmit a second DCI configured to schedule the second UL transmission without providing information in the second DCI for determining the precoding scheme of the second UL transmission.

28. The network entity of claim 25, wherein the precoding scheme comprises at least one of SRS resource indicator, transmit precoder matrix indicator, or modulation and coding scheme.

29. The network entity of claim 25, wherein the processor and the memory are further configured to, at least one of:
receive a request to stop a process for predicting the precoding scheme; or
transmit a command to start or stop the process for predicting the precoding scheme.

30. The network entity of claim 25, wherein the processor and the memory are further configured to, at least one of:
transmit information on an association between a downlink reference signal resource and an uplink reference signal resource for predicting the precoding scheme; or
transmit information on an association between a downlink reference signal resource and a machine learning model configured for predicting the precoding scheme.
